(19) United States
(12) Patent Application Publication
(10) Pub. No.: US 2026/0279651 A1
(43) Pub. Date: Sep. 17, 2026

(54) COIL COMPONENT, METHOD FOR MANUFACTURING COIL COMPONENT, AND ELECTRONIC/ELECTRIC DEVICE

(71) Applicant: DELTA ELECTRONICS (JAPAN), INC., Tokyo (JP)

(72) Inventors: Michio KAMIMURA, Tokyo (JP); Yoshitaka Uto, Tokyo (JP); Tomoya Kuwabara, Tokyo (JP); Masumi Shiraishi, Tokyo (JP); Naoki Sakazume, Tokyo (JP)

(73) Assignee: DELTA ELECTRONICS (JAPAN), INC., Tokyo (JP)

(21) Appl. No.: 19/632,398

(22) Filed: Mar. 29, 2026

Related U.S. Application Data
(63) Continuation of application No. PCT/JP2023/036594, filed on Oct. 6, 2023.

(51) Int. Cl. H01F 27/28; H01F 17/00; H01F 27/32; H01F 41/04; H01F 41/12

(52) U.S. Cl. CPC H01F 27/2804; H01F 17/0006; H01F 27/323; H01F 41/043; H01F 41/122

(57) ABSTRACT

A coil component achieving miniaturization and coil shape stability includes first and second spiral conductors, each shaped spiral when viewed in a first direction and aligned in the first direction, and a via VP electrically connecting an inner peripheral end of the first spiral conductor and an inner peripheral end of the second spiral conductor, and includes a coil conductor having a conductive path from an outer peripheral end of the first spiral conductor via the via VP to an outer peripheral end of the second spiral conductor. The coil conductor includes a first conductor extending along the conductive path and made of a first conductive material, and a second conductor made of a second conductive material and covering at least partially the first conductor. The second conductor is at least partially provided on a first end of the first spiral conductor on a side facing the second spiral conductor.

### CROSS REFERENCE TO RELATED APPLICATION

This application is a continuation application of PCT Application No. PCT/JP2023/036594, filed on Oct. 6, 2023. The content of the application is incorporated herein by reference.

### BACKGROUND OF THE INVENTION

### 1. FIELD OF THE INVENTION

The present invention relates to a coil component, a method for manufacturing the same, and an electronic/electric device on which the coil component is mounted.

### 2. DESCRIPTION OF THE RELATED ART

Patent Document 1 discloses a coil component including a main body including a coil that includes a top coil and a bottom coil connected to each other via a via, and an external electrode disposed on an outer surface of the main body and connected to the coil, wherein a first insulating layer is disposed on a surface of the top coil, a second insulating layer is disposed on a surface of the bottom coil, and the first and second insulating layers are disposed so as to extend between the top coil and the bottom coil.

As a method for manufacturing the above coil component, a method is disclosed that includes the steps of preparing an insulating film, processing a via hole penetrating the insulating film, disposing a conductive layer along a surface of the insulating film including upper and lower surfaces of the insulating film and the via hole, disposing a patterned insulating wall on the conductive layer, filling an opening of the patterned insulating wall with a plating layer, removing the insulating wall and the conductive layer disposed between the insulating wall and the insulating film, removing the insulating film, and forming an insulating layer covering the entire exposed surface.

### PRIOR ART DOCUMENT

### Patent Document

[Patent Document 1] US Patent Application Publication No. 2020/0027643

### SUMMARY OF THE INVENTION

### Problems to be Solved by the Invention

In the manufacturing method disclosed in Patent Document 1, the thickness of the insulating film defines the spacing between the top coil and the bottom coil. Since the insulating film, together with the insulating wall, is used to form a negative pattern of the top coil and the bottom coil, excessively reducing the thickness of the insulating film lowers the shape stability of the negative pattern, thereby causing instability of the coil shape. Accordingly, the insulating film is required to have a thickness sufficient to ensure a predetermined rigidity. However, the spacing between the top coil and the bottom coil, which is set based on this thickness, constitutes a dead space in the coil component and thus hinders miniaturization. Therefore, in the manufacturing method disclosed in Patent Document 1, in an embedded coil component, miniaturization and stability of the coil shape are in a trade-off relationship.

An object of the present invention is to provide a coil component capable of simultaneously achieving miniaturization of the coil component and stability of the coil shape, a method for manufacturing such a coil component, and an electronic/electric device in which the coil component is mounted.

### Means to Solve the Problems

In order to solve the above problems, the present inventors have conducted studies and obtained new knowledge that it is possible to narrow the distance between the top coil and the bottom coil by providing another conductor layer in the space obtained by removing the insulating layer.

In one aspect, the present invention provided based on this knowledge is a coil component including: a first spiral conductor portion and a second spiral conductor portion, each having a spiral shape when viewed in a first direction and arranged alongside in the first direction; and a via portion that electrically connects an inner peripheral end portion of the first spiral conductor portion and an inner peripheral end portion of the second spiral conductor portion, and having a coil conductor portion comprising a conductive path from an outer peripheral end portion of the first spiral conductor portion to an outer peripheral end portion of the second spiral conductor portion via the via portion, wherein the coil conductor portion has a first conductor portion extending along the conductive path and made of a first conductive material, and a second conductor portion made of a second conductive material and covering at least a part of the first conductor portion, and the second conductor portion is provided on at least a part of a first end portion of the first spiral conductor portion on a side facing the second spiral conductor portion. In such a coil component, the second conductor portion corresponds to the other conductive layer in the above knowledge.

In the above coil component, at least a part of turns of the first spiral conductor portion may have a first corner portion that connects a surface of the first end portion and a side surface along the first direction with a continuous surface.

In the manufacturing method disclosed in Patent Document 1, a coil is manufactured by disposing a conductive layer in a region surrounded by a patterned insulating wall and an insulating film. Therefore, when the insulating wall and the insulating film that have been in contact with the conductive layer are removed, the conductive layer that was in contact with the boundary between the insulating wall and the insulating film tends to have sharp corners. It is difficult to form an insulating layer at such corners, and even if formed, it easily peels off. Therefore, if the coil portion is covered with a material containing magnetic powder, there is a concern that direct contact between the magnetic powder and the coil may occur at the corners. Such direct contact causes a fatal defect as a component, such as a short circuit in the coil component. Therefore, as described above, instead of forming an insulating layer directly on the conductive layer (first conductor portion) that was in contact with the boundary between the insulating wall and the insulating film, by covering this conductive layer (first conductor portion) with another conductive layer (second conductor portion) and then forming an insulating layer, the sharpness of the shape of the corners where the insulating layer is formed is mitigated, the formation of the insulating layer at the corners is stabilized, and the formed insulating layer is less likely to peel off.

In a case where the above coil component has the first corner portion, in a first cross section obtained by cutting along a plane passing through the first corner portion and along the first direction, a cross-sectional line drawn by the first corner portion may have a shape approximating an arc having a larger radius of curvature than a cross-sectional line drawn by an interface between the second conductor portion and a portion made of a conductive material located inside the second conductor portion in the first cross section.

In the above coil component, a third conductor portion made of a third conductive material may be provided between the second conductor portion provided at the first end portion and the first conductor portion covered by the second conductor portion.

In the above coil component, the second conductor portion may be provided on at least a part of a second end portion of the second spiral conductor portion on a side facing the first spiral conductor portion.

In the above coil component, it is preferable that at least a part of turns of the second spiral conductor portion has a second corner portion that connects a surface of the second end portion and a side surface along the first direction with a continuous surface. In this case, in a second cross section obtained by cutting along a plane passing through the second corner portion and along the first direction, a cross-sectional line drawn by the second corner portion may have a shape approximating an arc having a larger radius of curvature than a cross-sectional line drawn by an interface between a portion made of a conductive material located inside the second conductor portion and the second conductor portion in the second cross section.

In a case where the above coil component has the second corner portion, a third conductor portion made of a third conductive material may be provided between the second conductor portion provided at the second end portion and the first conductor portion covered by the second conductor portion.

In the above coil component, at least one of the first spiral conductor portion and the second spiral conductor portion may have two turns arranged in a direction intersecting the first direction, and may include a first insulator portion covering at least a part of two opposing side surfaces in the two turns. The first insulator portion corresponds to the insulating layer in the above knowledge.

In a case of providing the first insulator portion, the first insulator portion may have a portion in contact with one of the two turns, a portion in contact with the other of the two turns, and a first connection portion extending continuously from these portions in a direction intersecting the first direction, and the first connection portion may have a thin portion whose thickness in the first direction is smaller than a portion in contact with either of the two turns in the first insulator portion.

In the case of providing the first insulator portion, the first insulator portion may have an intervening portion located between a turn of the first spiral conductor portion and a turn of the second spiral conductor portion, and at least one of a boundary surface and a pore may be present in the intervening portion.

In the case of providing the first insulator portion, the first insulator portion may be present so as to cover each of the two opposing side surfaces in the two turns, and at least one of a line segment boundary and a closed space may be present between these first insulator portions.

In the case of providing the first insulator portion, a second insulator portion made of a material different from a material constituting the first insulator portion may be located in at least a part between the first spiral conductor portion and the second spiral conductor portion. In this case, a third conductor portion made of a third conductive material may be provided between the second conductor portion provided at the first end portion and the first conductor portion covered by the second conductor portion.

The above coil component may further include: a main body portion containing magnetic powder and covering portions other than two end portions of the coil conductor portion; and external electrodes provided on the main body portion and electrically connected to each of the two end portions of the coil conductor portion exposed from the main body portion.

In another aspect, the present invention provides an electronic/electric device on which the above coil component is mounted, wherein the coil component is connected to a substrate at the external electrode. Examples of such an electronic/electric device include a power supply device provided with a power switching circuit, a voltage step-up/step-down circuit, a smoothing circuit, etc., and a compact portable communication device. Since the electronic/electric device according to the present invention includes the above coil component, it is excellent in terms of quality and dimensions.

In another aspect, the present invention provides a method for manufacturing a coil component including a coil conductor portion having a first spiral conductor portion and a second spiral conductor portion, each having a spiral shape when viewed in a first direction and arranged alongside in the first direction, and a via portion that electrically connects an inner peripheral end portion of the first spiral conductor portion and an inner peripheral end portion of the second spiral conductor portion, and having a conductive path from an outer peripheral end portion of the first spiral conductor portion to an outer peripheral end portion of the second spiral conductor portion via the via portion. The coil conductor portion has a first conductor portion extending along the conductive path and made of a first conductive material, and a second conductor portion made of a second conductive material and covering at least a part of the first conductor portion, and the first conductor portion has a first portion corresponding to the first spiral conductor portion, a second portion corresponding to the second spiral conductor portion, and a third portion corresponding to the via portion. Such a manufacturing method includes: forming the first portion on one of main surfaces of an insulating sheet substrate having a through hole, forming the second portion on the other of the main surfaces of the sheet substrate, and forming the third portion inside the through hole; regarding the sheet substrate, removing a portion that faces neither the first portion nor the second portion, and removing at least a part of a first opposing portion facing a surface of the first portion on a side proximal to the second portion, and a second opposing portion facing a surface of the second portion on a side proximal to the first portion; and forming the second conductor portion so as to cover an exposed portion of a member made of a conductive material including the first conductor portion.

In the sheet substrate, since at least a part of the first opposing portion facing the surface of the first portion on the side proximal to the second portion and the second opposing portion facing the surface of the second portion on the side proximal to the first portion is removed, the second conductor portion is formed in at least a part of a portion consisting of the first opposing portion and the second opposing portion, and a separation distance in the first direction between the first spiral conductor portion and the second spiral conductor portion can be narrowed.

In this case, since the corner portion of the second conductor portion formed so as to cover the corner portion where the surface intersecting the first direction and the first opposing portion connect in the first portion has a shape connecting a surface along the first direction and a surface intersecting the first direction with a continuous surface, a layer made of an insulating material (first insulator portion) is easily formed at this corner portion of the second conductor portion, and the formed layer (first insulator portion) is difficult to peel from the second conductor portion. Similarly, since the corner portion of the second conductor portion formed so as to cover the corner portion where the surface intersecting the first direction and the second opposing portion connect in the second portion has a shape connecting a surface along the first direction and a surface intersecting the first direction with a continuous surface, a layer made of an insulating material (first insulator portion) is easily formed at this corner portion of the second conductor portion, and the formed layer (first insulator portion) is difficult to peel from the second conductor portion.

In a case where the second conductor portion is formed by a plating process as described above, the main surface of the sheet substrate may have a third conductor portion made of a third conductive material, the first conductor portion may be formed by an electroplating process applying an electric current to the third conductor portion, and the exposed portion where the second conductor portion is formed may have a portion composed of the third conductor portion. In this case, a processing region of the main surface of the sheet substrate for the electroplating process may include a negative pattern of an insulating layer formed on the third conductor portion, and prior to the removal of the sheet substrate, portions of the insulating layer and the third conductor portion that do not contact the first conductor portion may be removed. Furthermore, it may be preferable that the third conductive material has different etching characteristics from the first conductive material.

In a case where the coil component has the third conductor portion as described above, the processing region of the main surface of the sheet substrate for the electroplating process may include a pattern of the third conductor portion having a shape corresponding to the first portion and the second portion.

In the method for manufacturing the coil component, an insulating material constituting the sheet substrate may remain in at least a part between the first portion and the second portion. In this case, the insulating material may have a portion in contact with the first portion and the second portion, or the sheet substrate may have a structure in which inorganic particles are dispersed in a matrix portion made of an organic material, and the insulating material may include the inorganic particles.

In the method for manufacturing the coil component, the first insulator portion may be formed so as to cover at least a part of the second conductor portion.

### Effect of the Invention

According to the present invention, a coil component capable of simultaneously achieving miniaturization and stability of the coil shape is provided. When this coil component is mounted on an electronic/electric device, the quality of the electronic/electric device can be stabilized, and the dimensions of the electronic/electric device can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view conceptually illustrating the shape of a coil component according to an embodiment of the present invention.

FIG. 2 is a diagram illustrating the structure of a coil conductor portion provided in the coil component according to an embodiment of the present invention.

FIG. 3 is an XY plan view illustrating the structure of a first spiral conductor portion provided in the coil component according to an embodiment of the present invention.

FIG. 4 is an XY plan view illustrating the structure of a second spiral conductor portion provided in the coil component according to an embodiment of the present invention.

FIG. 5 is an XZ cross-sectional view taken along line A-A′ in FIG. 2.

FIG. 6 is an enlarged view of a portion of FIG. 5.

FIG. 7 is an enlarged view of a portion of FIG. 6.

FIG. 8 is a diagram illustrating a detailed structure (first specific example) of a first insulator portion provided in the coil component according to an embodiment of the present invention.

FIG. 9 is a diagram illustrating a detailed structure (second specific example) of the first insulator portion provided in the coil component according to an embodiment of the present invention.

FIG. 10 is a diagram illustrating a detailed structure (third specific example) of the first insulator portion provided in the coil component according to an embodiment of the present invention.

FIG. 11 is a diagram illustrating a detailed structure (fourth specific example) of the first insulator portion provided in the coil component according to an embodiment of the present invention.

FIG. 12 is a diagram illustrating a detailed structure (Modification 1 of second specific example) of the first insulator portion provided in the coil component according to an embodiment of the present invention.

FIG. 13 is a diagram illustrating a detailed structure (Modification 2 of second specific example) of the first insulator portion provided in the coil component according to an embodiment of the present invention.

FIG. 14 is a diagram illustrating a detailed structure (Modification 3 of second specific example) of the first insulator portion provided in the coil component according to an embodiment of the present invention.

FIG. 15 is an XZ cross-sectional view for illustrating a modified example relating to the second conductor portion provided in the coil component according to an embodiment of the present invention.

FIG. 16 is a diagram (Part 1) illustrating an example of a manufacturing method of the coil component according to an embodiment of the present invention.

FIG. 17 is a diagram (Part 2) illustrating an example of a manufacturing method of the coil component according to an embodiment of the present invention.

FIG. 18 is a diagram (Part 3) illustrating an example of a manufacturing method of the coil component according to an embodiment of the present invention.

FIG. 19 is a diagram (Part 4) illustrating an example of a manufacturing method of the coil component according to an embodiment of the present invention.

FIG. 20 is a diagram (Part 5) illustrating an example of a manufacturing method of the coil component according to an embodiment of the present invention.

### DETAILED DESCRIPTION

Below, embodiments of the present invention will be described in detail with reference to the drawings.

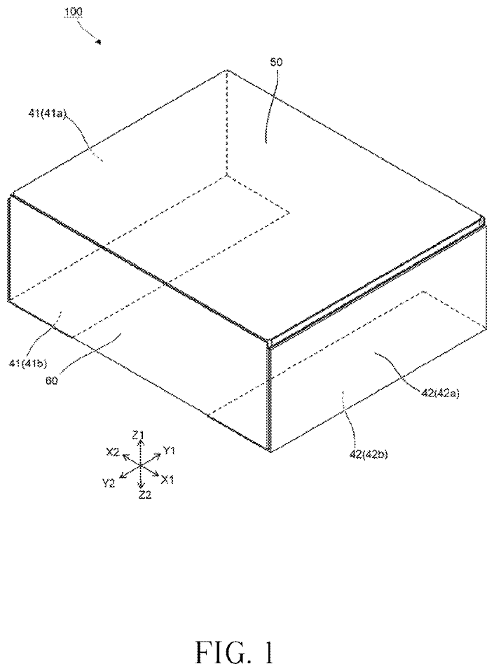

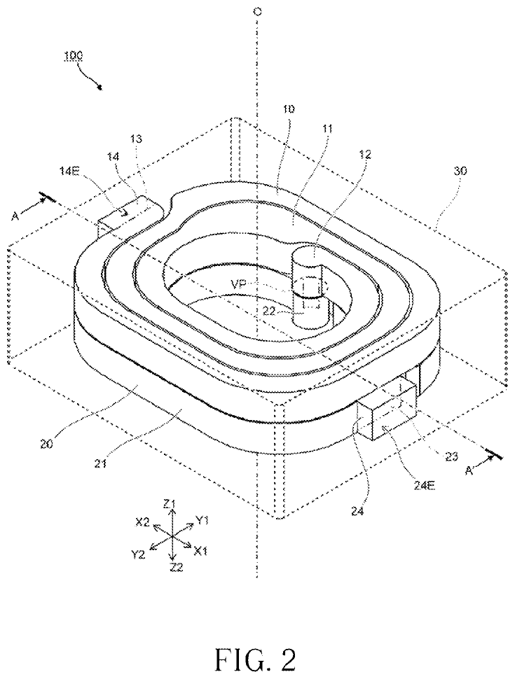

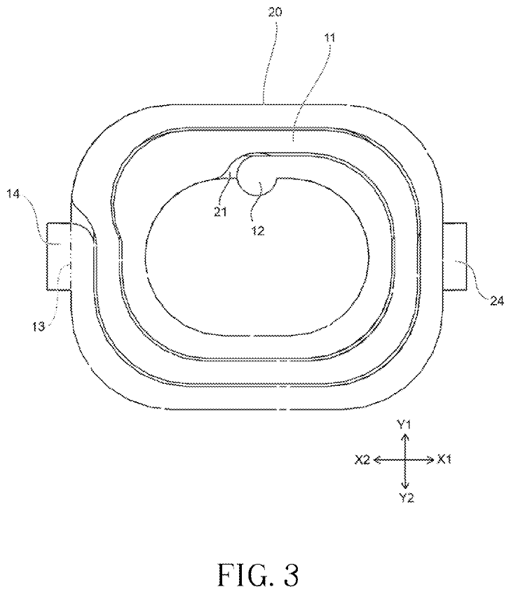

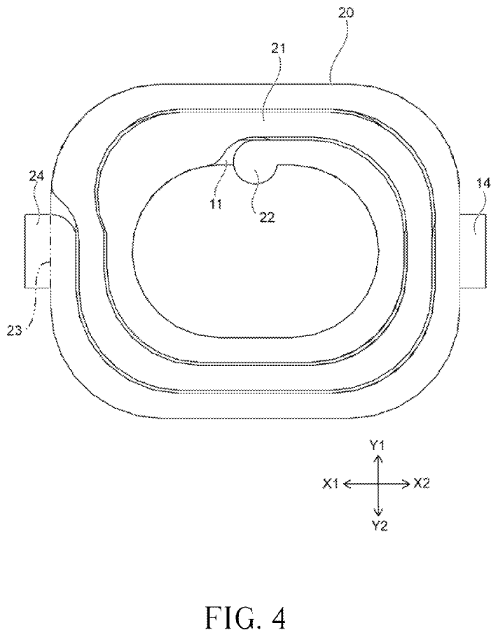

FIG. 1 is a perspective view conceptually illustrating the shape of a coil component according to an embodiment of the present invention. FIG. 2 is a diagram illustrating the structure of a coil conductor portion provided in the coil component according to an embodiment of the present invention. In FIG. 2, for convenience of explanation, the coil conductor portion is drawn with solid lines, the main body portion is drawn with broken lines, and other components are omitted. FIG. 3 is an XY plan view illustrating the structure of a first spiral conductor portion provided in the coil component according to an embodiment of the present invention. FIG. 4 is an XY plan view illustrating the structure of a second spiral conductor portion provided in the coil component according to an embodiment of the present invention. Note that FIG. 3 shows the coil conductor portion as viewed from the Z1 side in the Z1-Z2 direction, and FIG. 4 shows the coil conductor portion as viewed from the Z2 side in the Z1-Z2 direction.

### Overall Configuration

The coil component 100 according to an embodiment of the present invention includes a coil portion 10 having a coil conductor portion 20, a main body portion 30, a first external electrode 41, a second external electrode 42, and outer covers 50 and 60.

### Coil

As shown in FIG. 2 and FIG. 3, the coil portion 10 includes a coil conductor portion 20 having a first spiral conductor portion 11. The first spiral conductor portion 11 has a spiral shape around an axis O along a first direction (Z1-Z2 direction), extending from an inner peripheral end portion 12 which is an end portion on the inner peripheral side of the first spiral conductor portion 11 to an outer peripheral end portion 13 which is an end portion on the outer peripheral side of the first spiral conductor portion 11, while extending away from the axis O.

As shown in FIG. 2, when viewed from the Z1 side in the Z1-Z2 direction, the first spiral conductor portion 11 is arranged in a clockwise spiral from the inner peripheral end portion 12 toward the outer peripheral end portion 13. In the present specification, the term “spiral direction” of the first spiral conductor portion 11 refers to a direction from the inner peripheral end portion 12 toward the outer peripheral end portion 13. The same applies to a second spiral conductor portion 21 described below.

The conductor (conductive material) constituting the coil conductor portion 20 is not limited as long as it has appropriate conductivity. Metals such as copper, copper alloys, aluminum, and aluminum alloys can be cited as specific examples of the conductor constituting the coil conductor portion 20, and the coil conductor portion 20 can be manufactured using a film formation technique such as plating, for example. The coil portion 10 has an insulating coil insulator portion (not shown in FIGS. 1 to 4) on the surface of the coil conductor portion 20. By this coil insulator portion, insulation is ensured between adjacent conductors (between surfaces of conductors facing each other) in the coil conductor portion 20. The coil insulator portion is formed of, for example, a resin material.

No coil insulator portion is provided at the terminal end surfaces of the two end portions (the first lead-out portion end surface 14E and the second lead-out portion end surface 24E) of the coil conductor portion 20, and the coil portion 10 can be electrically connected to other members at these terminals.

As shown in FIG. 2 and FIG. 4, the coil conductor portion 20 has a second spiral conductor portion 21 arranged alongside the first spiral conductor portion 11 in the first direction. The second spiral conductor portion 21 has a spiral shape moving away from the axis O around the axis O along the first direction (Z1-Z2 direction), from an inner peripheral end portion 22 which is an end portion on the inner peripheral side in the second spiral conductor portion 21 toward an outer peripheral end portion 23 which is an end portion on the outer peripheral side in the second spiral conductor portion 21. In the second spiral conductor portion 21, the conductor is arranged in a spiral shape moving away from the axis O in the direction opposite to the first spiral conductor portion 11 (counterclockwise in FIG. 2) when viewed from the Z1 side in the Z1-Z2 direction. The average value of the separation distance in the first direction (Z1-Z2 direction) between the first spiral conductor portion 11 and the second spiral conductor portion 21 is not particularly limited. The smaller this separation distance is, the easier it is to lower the height (dimension in the Z1-Z2 direction) of the coil component 100, but if it is excessively small, the insulation between the first spiral conductor portion 11 and the second spiral conductor portion 21 tends to deteriorate. From the viewpoint of achieving both a low profile (low height) of the coil component 100 and high insulation between the first spiral conductor portion 11 and the second spiral conductor portion 21, it may be preferable that the separation distance is 0.4 μm or more and 20 μm or less. In terms of manufacturing, in order to reduce variations in the separation distance and to support the coil toward a common in-plane direction more reliably, this separation distance is more preferably 1.0 μm or more, and even more preferably 5.0 μm or more.

The inner peripheral end portion 12 of the first spiral conductor portion 11 and the inner peripheral end portion 22 of the second spiral conductor portion 21 are electrically connected by a via portion VP. The via portion VP may be formed of the same conductor as the coil conductor portion 20. In a specific example, the via portion VP is of the same material as the first spiral conductor portion 11 and the second spiral conductor portion 21, and is manufactured simultaneously with the first spiral conductor portion 11 and the second spiral conductor portion 21. In this case, the via portion VP is integrated with the inner peripheral end portion 12 of the first spiral conductor portion 11 and the inner peripheral end portion 22 of the second spiral conductor portion 21.

A first lead-out portion 14 is continuously provided at the outer peripheral end portion 13 of the first spiral conductor portion 11, and a second lead-out portion 24 is continuously provided at the outer peripheral end portion 23 of the second spiral conductor portion 21. Therefore, the outer peripheral end portion 13 of the first spiral conductor portion 11 is substantially the interface with the first lead-out portion 14, and the outer peripheral end portion 23 of the second spiral conductor portion 21 is substantially the interface with the second lead-out portion 24. In a specific example, the first lead-out portion 14 and the second lead-out portion 24 are of the same material as the first spiral conductor portion 11 and the second spiral conductor portion 21, and are manufactured simultaneously with the first spiral conductor portion 11 and the second spiral conductor portion 21. In this case, the first lead-out portion 14 is integrated with the outer peripheral end portion 13 of the first spiral conductor portion 11 without a boundary, and the second lead-out portion 24 is integrated with the outer peripheral end portion 23 of the second spiral conductor portion 21 without a boundary.

That is, in this embodiment, the coil conductor portion 20 has the first spiral conductor portion 11 and the second spiral conductor portion 21, the via portion VP, and the first lead-out portion 14 and the second lead-out portion 24, which are formed of a common conductive material. Thereby, the coil conductor portion 20 has a conductive path leading from the outer peripheral end portion 13 of the first spiral conductor portion 11 through the first spiral conductor portion 11 to the inner peripheral end portion 12, passing through the via portion VP in contact with the inner peripheral end portion 12 to the inner peripheral end portion 22 of the second spiral conductor portion 21, and from the inner peripheral end portion 22 through the second spiral conductor portion 21 to the outer peripheral end portion 23 of the second spiral conductor portion 21.

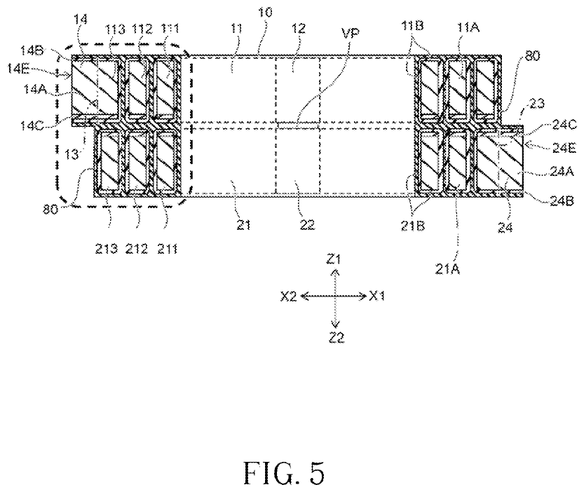

FIG. 5 is a cross-sectional view (XZ cross-sectional view) taken along the XZ plane (the plane indicated by the line A-A′ in FIG. 2) for illustrating the structure of the coil portion provided in the coil component according to an embodiment of the present invention. In FIG. 5, elements other than the coil portion 10 are hidden.

As shown in the cross section of FIG. 5, the turns of the first spiral conductor portion 11 and the turns of the second spiral conductor portion 21 are positioned so as to be aligned in the first direction. The first spiral conductor portion 11 includes a first inner-side turn 111 which is a turn positioned at the innermost periphery, a first outer-side turn 113 which is a turn positioned at the outermost periphery, and a first central turn 112 which is a turn positioned between these, and the second spiral conductor portion 21 includes a second inner-side turn 211 which is a turn positioned at the innermost periphery, a second outer-side turn 213 which is a turn positioned at the outermost periphery, and a second central turn 212 which is a turn positioned between these.

The second inner-side turn 211 is positioned on the Z2 side in the Z1-Z2 direction of the first inner-side turn 111, the second outer-side turn 213 is positioned on the Z2 side in the Z1-Z2 direction of the first outer-side turn 113, and the second central turn 212 is positioned on the Z2 side in the Z1-Z2 direction of the first central turn 112. In the coil portion 10 shown in FIG. 5, the second lead-out portion 24 does not exist on the Z2 side in the Z1-Z2 direction of the outer peripheral end portion 13 of the first spiral conductor portion 11, and the first lead-out portion 14 does not exist on the Z1 side in the Z1-Z2 direction of the outer peripheral end portion 23 of the second spiral conductor portion 21.

### First Conductor Portion, Second Conductor Portion

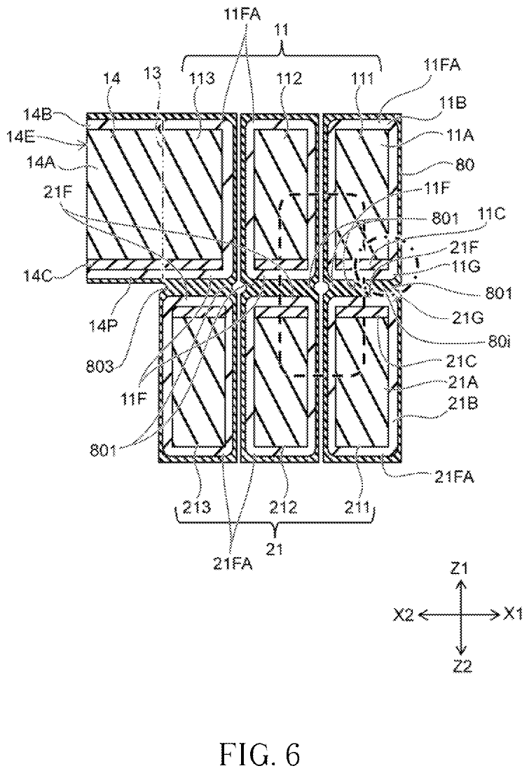

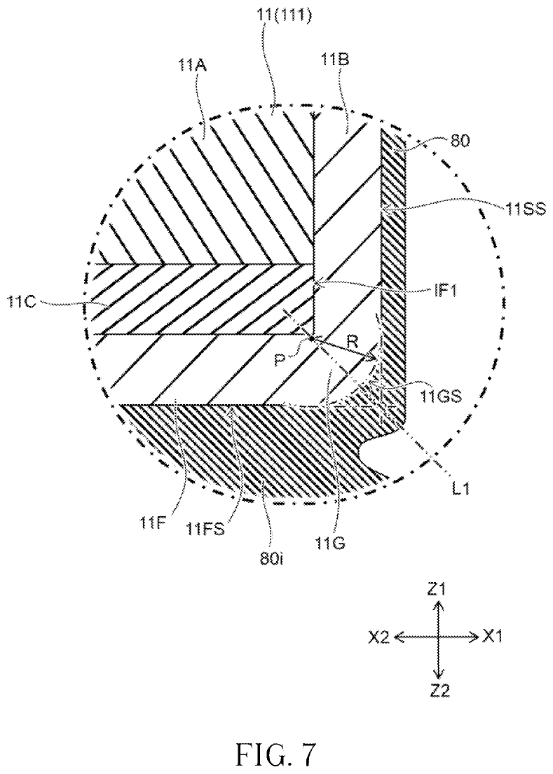

FIG. 6 is a partially enlarged view of the region surrounded by the broken line in FIG. 5. FIG. 7 is a partially enlarged view of the region surrounded by the dot-dash line in FIG. 6.

As shown in FIG. 5 and FIG. 6, the first spiral conductor portion 11 has a first conductor portion 11A extending along a conductive path leading from the outer peripheral end portion 13 of the first spiral conductor portion 11 to the outer peripheral end portion 23 of the second spiral conductor portion 21 via the via portion VP and made of a first conductive material, and a second conductor portion 11B made of a second conductive material and covering at least a part of the first conductor portion 11A.

As will be described later, in one example, the first conductor portion 11A and the second conductor portion 11B are manufactured by different manufacturing processes. In this case, even if they are the same type of material (e.g., Cu, Cu alloy, etc., materials containing Cu), they can be distinguished by cross-sectional observation because microstructural characteristics such as crystal structure, crystal orientation, and crystal growth direction are different. In a specific example, the first conductor portion 11A is formed of an electroplated deposit (electrolytic plated deposit), and the second conductor portion 11B is formed of a plated deposit In this case, the plated deposit may be an electroplated deposit or an electroless plated deposit. From the viewpoint of improving the controllability of the thickness of the second conductor portion 11B, it may be preferable that the plated deposit is an electroplated deposit.

In this embodiment, an end portion of the first conductor portion 11A on the side facing the second spiral conductor portion 21 (Z2 side in the Z1-Z2 direction) in the first direction (Z1-Z2 direction) is provided with a third conductor portion 11C as shown in FIG. 6. The third conductive material constituting the third conductor portion 11C is not limited. It may be of the same type as the material constituting the first conductor portion 11A (e.g., Cu, Cu alloy, etc., materials containing Cu), or it may be different. From a manufacturing viewpoint (base layer for electroplating), it may be preferable that the third conductor portion 11C is made of a material containing at least one of Ni and Cr. It may be preferable that the material constituting the first conductor portion 11A and the material constituting the third conductor portion 11C have different etching characteristics. For example, when the first conductor portion 11A is made of Cu and the third conductor portion 11C is made of Ni, it is possible to etch Ni with high selectivity depending on the etching conditions. The third conductor portion 11C may be in the form of a film, or may be composed of a laminated film of different materials.

In this embodiment, the second conductor portion 11B is provided so as to cover at least a part, specifically the entirety, of a first end portion 11F of the first spiral conductor portion 11 on the side facing the second spiral conductor portion 21.

Similarly to the first spiral conductor portion 11, the second spiral conductor portion 21 also has a first conductor portion 21A extending along the conductive path and made of the first conductive material, and a second conductor portion 21B made of the second conductive material and covering at least a part of the first conductor portion 21A, and in this embodiment, further has a third conductor portion 21C (see FIG. 6) made of a third conductive material at an end portion of the first conductor portion 21A on the side facing the first spiral conductor portion 11 (Z1 side in the Z1-Z2 direction) in the first direction (Z1-Z2 direction). Moreover, the second conductor portion 21B is provided so as to cover at least a part, specifically the entirety, of a second end portion 21F of the second spiral conductor portion 21 on the side facing the first spiral conductor portion 11.

As described above, since the second conductor portion 11B is provided at the first end portion 11F and the second conductor portion 21B is provided at the second end portion 21F, the separation distance between the first spiral conductor portion 11 and the second spiral conductor portion 21 is shorter than the separation distance between the third conductor portion 11C and the third conductor portion 21C. When the first conductor portion 11A is formed by electroplating and the third conductor portion 11C is a base layer for electroplating, and the second conductor portion 21B is formed by electroplating and the third conductor portion 21C is a base layer for electroplating, the separation distance between the first spiral conductor portion 11 and the second spiral conductor portion 21 is equal to the separation distance between the third conductor portion 11C and the third conductor portion 21C as described in Patent Document 1. However, in this embodiment, since the second conductor portion 11B is provided closer to the second spiral conductor portion 21 than the third conductor portion 11C, and the second conductor portion 21B is provided closer to the first spiral conductor portion 11 than the third conductor portion 21C, the separation distance between the first spiral conductor portion 11 and the second spiral conductor portion 21 can be shortened. As a result, the dead space is reduced, making it easier to enhance the characteristics and miniaturize the coil component 100.

As shown in FIG. 5, similarly to the first spiral conductor portion 11 and the second spiral conductor portion 21, the first lead-out portion 14 and the second lead-out portion 24 also have first conductor portions 14A, 24A, second conductor portions 14B, 24B, and third conductor portions 14C, 24C. That is, the first conductor portions 14A, 11A, 21A, 24A extend along the conductive path of the coil conductor portion 20 from the first lead-out portion end face 14E through the first lead-out portion 14, the first spiral conductor portion 11, the via portion VP, the second spiral conductor portion 21 and the second lead-out portion 24 to the second lead-out portion end face 24E.

### First Corner Portion, Second Corner Portion

FIG. 7 is an enlarged view of the region surrounded by the dot-dash line in FIG. 6. FIG. 7 shows the inner peripheral side and the first end portion 11F side (Z2 side in the Z1-Z2 direction) of the first inner-side turn 111.

The first inner-side turn 111 has a first corner portion 11G that connects a surface 11FS of the first end portion 11F and a side surface along the first direction, specifically an inner peripheral side surface 11SS, with a continuous surface. By virtue of having such a first corner portion 11G, a surface 11GS of the first corner portion 11G becomes a gently curved surface (a surface without sharp bending). On such a surface, a first insulator portion 80 (details will be described later) is easily formed, and the formed first insulator portion 80 is difficult to peel off. If the first insulator portion 80 peels off, the magnetic powder contained in the main body portion 30 would come into direct contact with the first inner-side turn 111 (first spiral conductor portion 11). When the magnetic powder includes a metallic portion, such contact would cause short circuit in the coil conductor portion 20 through the magnetic powder. Therefore, the coil component 100 according to this embodiment including the first spiral conductor portion 11 having the first corner portion 11G is excellent in quality stability.

In a first cross section obtained by cutting along a plane passing through the first corner portion 11G and along the first direction, a cross-sectional line drawn by the first corner portion 11G has a shape approximating an arc having a radius of curvature larger than that of a cross-sectional line drawn by an interface IF1 between the second conductor portion 11B and a portion made of a conductive material located inside the second conductor portion 11B, which is the third conductor portion 11C in FIG. 7, in the first cross section. The first cross section is typically a plane including the axis O and orthogonal to the XY plane, and in the specific example shown in FIG. 7, the first cross section consists of the XZ cross section taken along the line A-A′ in FIG. 2. A radius R of an arc having a center P on an angle bisector L1 defined by a line formed by the surface 11FS of the first end portion 11F and a line formed by the inner peripheral side surface 11SS of the first inner-side turn 111, and approximating the line formed by the surface 11GS of the first corner portion 11G, is larger than a radius of an approximated arc similarly obtained for a line formed by the interface IF1 between the portion made of the conductive material located inside the second conductor portion 11B (specifically, the third conductor portion 11C) and the second conductor portion 11B.

As a result of the large radius of the approximated arc, the surface (surface 11GS) on which the first insulator portion 80 is formed becomes a gently curved surface, and the possibility of short circuit in the coil conductor portion 20 can be stably reduced.

Although not illustrated in detail, as shown in FIG. 6, at least a part of the turns of the second spiral conductor portion 21 has a second corner portion 21G that connects a surface of the second end portion 21F and a side surface along the first direction with a continuous surface. In addition, in a second cross section obtained by cutting along a plane passing through this second corner portion 21G and along the first direction, a cross-sectional line drawn by the second corner portion 21G has a shape approximating an arc having a radius of curvature larger than that of a cross-sectional line drawn by an interface between the second conductor portion 21B and a portion made of a conductive material located inside the second conductor portion 21B (third conductor portion 21C) in the second cross section. Like the first cross section, the second cross section is also typically a plane including the axis O and orthogonal to the XY plane, and a specific example of the second cross section is the XZ cross section taken along the line A-A′ in FIG. 2.

### First Insulator Portion

The coil insulator portion has a first insulator portion 80, and as shown in FIG. 6, the first insulator portion 80 is provided on at least a part of the surface of the first spiral conductor portion 11 and the surface of the second spiral conductor portion 21.

In this embodiment, the first insulator portion 80 is thermoplastic and includes a thermoplastic resin containing a parylene-based polymer. Other examples of thermoplastic resins include polyethylene, polypropylene, polyamide, polyester, polyamide-imide, polyimide, polysulfone, polycarbonate, liquid crystal polymer, polyvinylidene fluoride, polytetrafluoroethylene, and the like. The first insulator portion 80 only needs to have thermoplasticity as a whole, and may contain, for example, inorganic insulating particles in addition to the above thermoplastic resin.

The first insulator portion 80 preferably has excellent insulating properties, and specifically, it may be preferable that the volume resistivity obtained by ASTM D257 is 1.0×10¹⁴ Ωcm or more. This volume resistivity is more preferably 1.0×10¹⁵ Ωcm or more, and further preferably 1.0×10¹⁶ Ωcm or more. The upper limit of the volume resistivity is not particularly limited. The volume resistivity may be 1.0×10²⁰ Ωcm or less. The first insulator portion 80 preferably has excellent dielectric characteristics, and specifically, it may be preferable that the relative permittivity at 60 Hz obtained by ASTM D150 is 4.0 or less. This relative permittivity is more preferably 3.5 or less, and further preferably 3.0 or less. The upper limit of this relative permittivity is not particularly limited. The relative permittivity may be 1.0 or more. Methods for measuring the volume resistivity and relative permittivity of the first insulator portion 80 are not limited as long as results equivalent to the results obtained by the above ASTM D257 and D150 are expected. For example, a measurement sample obtained by preparing a material corresponding to the first insulator portion 80 to dimensions required for measurement may be separately prepared, and the constituent material may be specified through analytical methods such as component analysis and FT-IR using this measurement sample, and characteristics such as volume resistivity may be evaluated for that material.

The first insulator portion 80 has a portion that comes into contact with a portion of the first spiral conductor portion 11 on the side opposite to the side facing the second spiral conductor portion 21, that is, an opposing portion relative to the second spiral conductor portion 21 in the first spiral conductor portion 11 (first opposite portion 11FA). In FIG. 6, end portions on the Z1 side in the Z1-Z2 direction of the first inner-side turn 111, the first central turn 112, and the first outer-side turn 113, as well as the first lead-out portion 14 connected to the first outer-side turn 113 are the first opposite portion 11FA, and the first insulator portion 80 is provided so as to be in contact with this first opposite portion 11FA.

The first insulator portion 80 has a portion that comes into contact with an opposing portion relative to the first spiral conductor portion 11 in the second spiral conductor portion 21 (second opposite portion 21FA). In FIG. 6, end portions on the Z2 side in the Z1-Z2 direction of the second inner-side turn 211, the second central turn 212, and the second outer-side turn 213 are the second opposite portion 21FA, and the first insulator portion 80 has a portion in contact with this second opposite portion 21FA.

The first insulator portion 80 has a portion that comes into contact with a side portion of the first spiral conductor portion 11 along the spiral direction. To specifically explain the side portion using the first inner-side turn 111, the first inner-side turn 111 has a side portion facing the inner peripheral side (X1 side in X1-X2 direction) and a side portion facing the outer peripheral side (X2 side in X1-X2 direction) and opposing the first central turn 112. The first insulator portion 80 has portions in contact with these side portions. The first insulator portion 80 is not provided on the end face on the outer peripheral side (X2 side in X1-X2 direction) of the outer peripheral end portion 13 of the first spiral conductor portion 11 (first lead-out portion end face 14E) so as to allow electrical connection with another member (first external electrode 41).

The first insulator portion 80 has a portion that comes into contact with a side portion of the second spiral conductor portion 21 along the spiral direction. To specifically explain the side portion using the second inner-side turn 211, the second inner-side turn 211 has a side portion facing the inner peripheral side (X1 side in X1-X2 direction) and a side portion facing the outer peripheral side (X2 side in X1-X2 direction) and opposing the second central turn 212. The first insulator portion 80 has portions in contact with these side portions. Although not shown, the first insulator portion 80 is not provided on the side surface on the outer peripheral side (X1 side in X1-X2 direction) of the outer peripheral end portion 23 of the second spiral conductor portion 21 (second lead-out portion end face 24E, see FIG. 5) so as to allow electrical connection with another member (second external electrode 42).

From the viewpoint of stably realizing the provision of the first insulator portion 80 on the side portions, it may be preferable that an average width of gaps between two turns lined up in a direction (XY in-plane direction) intersecting the first direction (Z1-Z2 direction) is 0.025 times or more and 0.25 times or less an average value of widths of the two turns in the lined-up direction.

An average value of a thickness of a portion of the first insulator portion 80 in contact with the first opposite portion 11FA (opposing portion of first spiral conductor portion 11 relative to second spiral conductor portion 21), a thickness of a portion in contact with the second opposite portion 21FA (opposing portion of second spiral conductor portion 21 relative to first spiral conductor portion 11), a thickness of a portion in contact with the side portion of the first spiral conductor portion 11, and a thickness of a portion in contact with the side portion of the second spiral conductor portion 21 is preferably 0.2 μm or more and 10 μm or less from the viewpoint that the first insulator portion 80 has good insulating properties. From the viewpoint of more stably ensuring insulation, this average value is more preferably 1.0 μm or more.

The first insulator portion 80 has a first connection portion 801 positioned so as to connect a portion in contact with a side portion of a first turn that is at least one of turns that the first spiral conductor portion 11 has (in this embodiment, first inner-side turn 111, first central turn 112, and first outer-side turn 113) and a portion in contact with a side portion of a second turn that is closest to the side portion of the first turn in the second spiral conductor portion 21. From the viewpoint that the first connection portion 801 is stably formed, it may be preferable that the average value of the separation distance in the first direction (Z1-Z2 direction) between the first spiral conductor portion 11 and the second spiral conductor portion 21 is 0.4 μm or more and 20 μm or less.

Taking a case where the first turn is the first inner-side turn 111 as a specific example, the second turn closest to the side portion of the first turn (first inner-side turn 111) in the second spiral conductor portion 21 is the second inner-side turn 211. The first insulator portion 80 positioned so as to connect the first insulator portion 80 in contact with the side portion on the inner peripheral side (X1 side in X1-X2 direction) of the first inner-side turn 111 and the first insulator portion 80 in contact with the side portion on the inner peripheral side (X1 side in X1-X2 direction) of the second inner-side turn 211 is the first connection portion 801.

Further, FIG. 6 illustrates a first connection portion 801 connecting the first insulator portion 80 in contact with the side portion on the outer peripheral side (X2 side in the X1-X2 direction) of the first inner-side turn 111 and the first insulator portion 80 in contact with the side portion on the outer peripheral side (X2 side in the X1-X2 direction) of the second inner-side turn 211, a first connection portion 801 connecting the first insulator portion 80 in contact with the side portion on the inner peripheral side (X1 side in the X1-X2 direction) of the first central turn 112 and the first insulator portion 80 in contact with the side portion on the inner peripheral side (X1 side in the X1-X2 direction) of the second central turn 212, a first connection portion 801 connecting the first insulator portion 80 in contact with the side portion on the outer peripheral side (X2 side in the X1-X2 direction) of the first central turn 112 and the first insulator portion 80 in contact with the side portion on the outer peripheral side (X2 side in the X1-X2 direction) of the second central turn 212, and a first connection portion 801 connecting the first insulator portion 80 in contact with the side portion on the inner peripheral side (X1 side in the X1-X2 direction) of the first outer-side turn 113 and the first insulator portion 80 in contact with the side portion on the inner peripheral side (X1 side in the X1-X2 direction) of the second outer-side turn 213.

By having the first connection portion 801 in this way, the volume of the coil insulator portion can be reduced, which makes it easy to enhance the electrical characteristics of the coil component 100 and to meet the demand for miniaturization of the coil component 100.

The first insulator portion 80 has a portion in contact with an opposing portion (first end portion 11F) of the first spiral conductor portion 11 relative to the second spiral conductor portion 21, and a portion in contact with an opposing portion (second end portion 21F) of the second spiral conductor portion 21 relative to the first spiral conductor portion 11. In the first insulator portion 80 shown in FIG. 6, these portions integrally form an intervening portion 80i, and the intervening portion 80i and the first connection portion 801 are integrated. In the intervening portion 80i, the first insulator portion 80 in contact with the opposing portion (first end portion 11F) of the first spiral conductor portion 11 relative to the second spiral conductor portion 21 comes into contact with the second spiral conductor portion 21 as well without a connection boundary. By providing such a configuration, it becomes easy to enhance the insulation between the first spiral conductor portion 11 and the second spiral conductor portion 21.

The first insulator portion 80 in contact with the side portion on the outer peripheral side (X2 side in the X1-X2 direction) of the second outer-side turn 213 has a third connection portion 803 that is a portion connecting the first insulator portion 80 in contact with a first extension portion 14P, which is a portion on the Z2 side in the Z1-Z2 direction of the first lead-out portion 14 and extending from the first end portion 11F of the first outer-side turn 113, and the first insulator portion 80 in contact with the side portion on the outer peripheral side (X2 side in the X1-X2 direction) of the second outer-side turn 213. This third connection portion 803 is also provided between the first insulator portion 80 in contact with the side portion on the outer peripheral side (X1 side in the X1-X2 direction) of the first outer-side turn 113 and the first insulator portion 80 in contact with the portion on the Z1 side in the Z1-Z2 direction of the second lead-out portion 24.

The first insulator portion 80 shown in FIG. 6 comes into contact with a portion of the coil conductor portion 20 located inside the main body portion 30. Specifically, the first insulator portion 80 is provided so as to come into contact with portions other than the outer (X2 side in the X1-X2 direction) end portion (first lead-out portion end face 14E) of the first lead-out portion 14 and the outer (X1 side in the X1-X2 direction) end portion (second lead-out portion end face 24E, not shown in FIG. 6) of the second lead-out portion 24 in the coil conductor portion 20. As a result, even if the surface of the magnetic powder contained in the main body portion 30 has conductivity, short-circuiting inside the coil conductor portion 20 caused by contact between the coil conductor portion 20 and the magnetic powder can be stably avoided.

From the viewpoint of more stably realizing short-circuit prevention inside the coil conductor portion 20, the first insulator portion 80 in contact with the first spiral conductor portion 11 preferably comes into contact with the turns continuously without a connection boundary among the portion in contact with the opposing portion relative to the second spiral conductor portion 21 (first end portion 11F), the portion in contact with the opposing portion relative to the second spiral conductor portion 21 (first opposite portion 11FA), and the portion in contact with the side surface, for all turns of the first spiral conductor portion 11. Similarly, the first insulator portion 80 in contact with the second spiral conductor portion 21 preferably comes into contact with the turns continuously without a connection boundary among the portion in contact with the opposing portion relative to the first spiral conductor portion 11 (second end portion 21F), the portion in contact with the opposing portion relative to the second spiral conductor portion 21 (second opposite portion 21FA), and the portion in contact with the side surface, for all turns of the second spiral conductor portion 21.

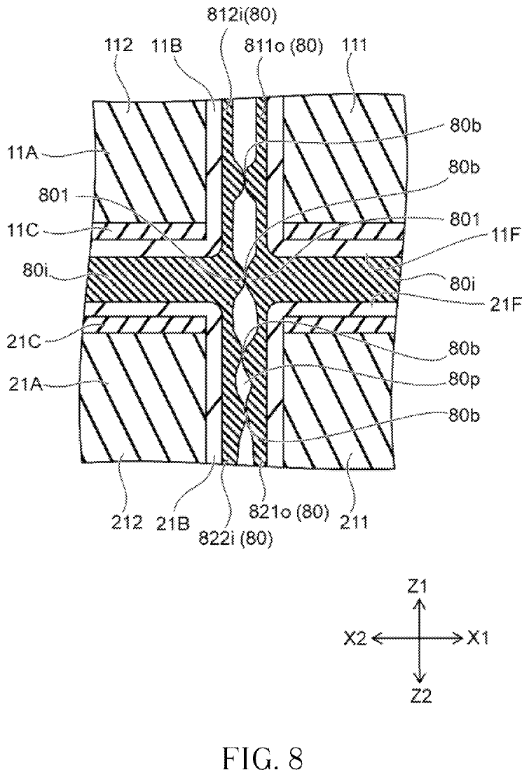

Hereinafter, the detailed structure of the first insulator portion 80 in the first embodiment will be described using FIGS. 8 to 14 corresponding to the region surrounded by the broken line in FIG. 6. That is, all of FIGS. 8 to 14 are diagrams illustrating the detailed structure of the first insulator portion 80 in the first embodiment. In any of the figures, at least one of the first spiral conductor portion 11 and the second spiral conductor portion 21 has two turns lined up in the X1-X2 direction, which is a direction intersecting the first direction (Z1-Z2 direction). Specifically, the first spiral conductor portion 11 has the first inner-side turn 111 and the first central turn 112, and the second spiral conductor portion 21 has the second inner-side turn 211 and the second central turn 212.

### First Specific Example

FIG. 8 is a diagram illustrating a detailed structure (first specific example) of a first insulator portion provided in the coil component according to an embodiment of the present invention. In the first specific example, the first insulator portion 80 in contact with one of two opposing surfaces of side portions in the two turns and the first insulator portion 80 in contact with the other of the two side portions come into contact with each other, and two first connection portions 801 present in the two turns contact with each other with a boundary surface 80b.

Specifically, the first insulator portion 811o in contact with the side portion on the outer peripheral side (X2 side in X1-X2 direction) of the first inner-side turn 111 is has one portion in contact with the first insulator portion 812i in contact with the opposing side portion on the inner peripheral side (X1 side in X1-X2 direction) of the first central turn 112, and a boundary surface 80b serving as a line segment boundary exists at the contacting portion. Similarly, the first insulator portion 821o in contact with the side portion on the outer peripheral side (X2 side in X1-X2 direction) of the second inner-side turn 211 has two portions in contact with the first insulator portion 822i in contact with the opposing side portion on the inner peripheral side (X1 side in X1-X2 direction) of the second central turn 212, and a boundary surface 80b exists at the contacting portions. In addition, a pore 80p serving as a closed space is formed by the two contacting portions. Such boundary surfaces 80b and pores 80p can absorb the displacement of the coil portion 10 when the coil portion 10 thermally expands due to heat generated when the coil component 100 operates, and can reduce stress applied to the magnetic powder in the main body portion 30 near the coil portion 10, which easily causes magnetic saturation. Therefore, the boundary surfaces 80b and the pores 80p can improve the DC superimposition rated current of the electronic component.

Furthermore, a first connection portion 801 is present for each of the first inner-side turn 111 and the first central turn 112, and these two first connection portions 801 are in contact with each other with a boundary surface 80b. An intervening portion 80i exists between the first inner-side turn 111 and the second inner-side turn 211, and an intervening portion 80i also exists between the first central turn 112 and the second central turn 212. These intervening portions 80i are all integrated with the first connection portion 801.

### Second Specific Example

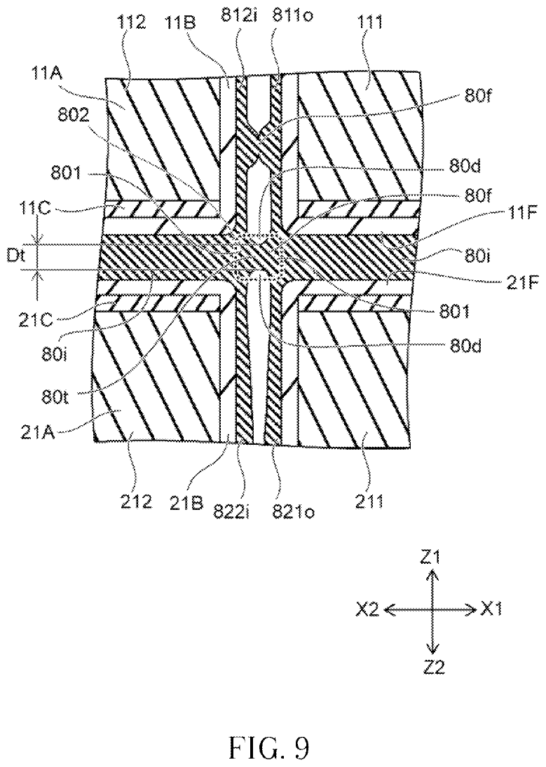

FIG. 9 is a diagram illustrating a detailed structure (second specific example) of the first insulator portion provided in the coil component according to an embodiment of the present invention. In the second specific example, the first insulator portion 80 in contact with one of two opposing side surfaces in the two turns and the first insulator portion 80 in contact with the other of the two side surfaces are integrated, and two first connection portions 801 present in the two turns are integrated.

Specifically, the first insulator portion 811o in contact with the side portion on the outer peripheral side (X2 side in X1-X2 direction) of the first inner-side turn 111 has one integrated portion with the first insulator portion 812i in contact with the opposing side portion on the inner peripheral side (X1 side in X1-X2 direction) of the first central turn 112, and the integrated portion is a fusion portion 80f.

Furthermore, a first connection portion 801 is present for each of the first inner-side turn 111 and the first central turn 112, and these two first connection portions 801 are integrated with a fusion portion 80f. An intervening portion 80i exists between the first inner-side turn 111 and the second inner-side turn 211, and an intervening portion 80i also exists between the first central turn 112 and the second central turn 212. These intervening portions 80i are all integrated with the first connection portion 801.

That is, at least one of the two first connection portions 801 has at least one of a portion in contact with the opposing portion relative to the first spiral conductor portion 11 (first end portion 11F) and a portion in contact with the opposing portion relative to the second spiral conductor portion 21 (second end portion 21F). In FIG. 8, both of the two first connection portions 801 have a portion in contact with the opposing portion relative to the first spiral conductor portion 11 (first end portion 11F) and a portion in contact with the opposing portion relative to the second spiral conductor portion 21 (second end portion 21F).

The first insulator portion 80 including two first connection portions 801 provided with the fusion portion 80f shown in FIG. 9 has a portion in contact with one of the two turns (for example, the first inner-side turn 111), a portion in contact with the other of the two turns (first central turn 112), and a second connection portion 802 (a region surrounded by a dotted line in FIG. 9) extending continuously from these portions in a direction intersecting the first direction (Z1-Z2 direction) (X1-X2 direction in FIG. 9).

The second connection portion 802 consists of a portion including the fusion portion 80f in the two first insulator portions 80. The second connection portion 802 has a thin portion 80t whose thickness in the first direction (Z1-Z2 direction) is smaller than a portion in contact with either of the two turns in the first insulator portion 80. It may be preferable that a thickness Dt of the thin portion 80t in the first direction (Z1-Z2 direction) has a ratio of 0.6 or more to a thickness in the first direction (Z1-Z2 direction) in other portions of the second connection portion 802. In this case, a concave portion 80d is formed by the thin portion 80t, and it is easy to realize that a ratio of a depth of the concave portion 80d to the thickness in the first direction (Z1-Z2 direction) in other portions of the second connection portion 802 is 0.2 or less.

### Third Specific Example

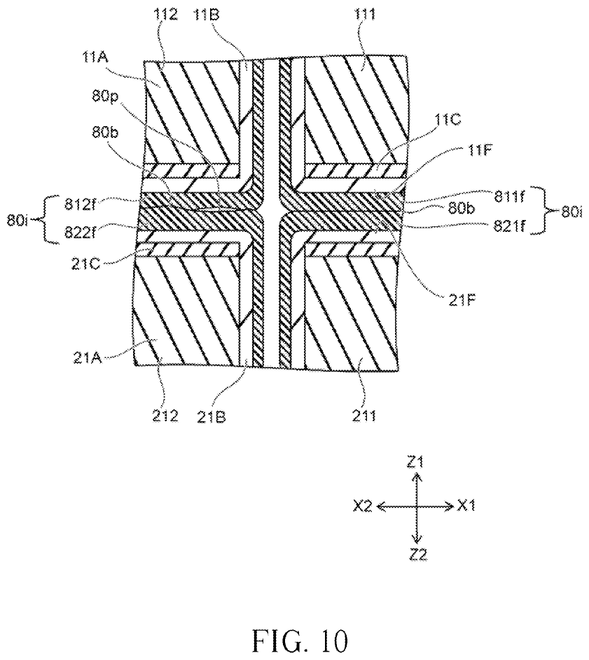

FIG. 10 is a diagram illustrating a detailed structure (third specific example) of the first insulator portion provided in the coil component according to an embodiment of the present invention. The intervening portions 80i of the first insulator portions 80 shown in FIG. 8 and FIG. 9 are integrally provided between the first spiral conductor portion 11 and the second spiral conductor portion 21, in contact with both of them, but the intervening portion 80i shown in FIG. 10 is not integrated therewith. Specifically, the intervening portion 80i has an opposing contact portion 811f in contact with the first end portion 11F of the first inner-side turn 111 and an opposing contact portion 821f in contact with the second end portion 21F of the second inner-side turn 211, and a boundary surface 80b exists between them. Furthermore, the intervening portion 80i has an opposing contact portion 812f in contact with the first end portion 11F of the first central turn 112 and an opposing contact portion 822f in contact with the second end portion 21F of the second central turn 212, and a boundary surface 80b exists between them, and further, pores 80p also exist.

### Fourth Specific Example

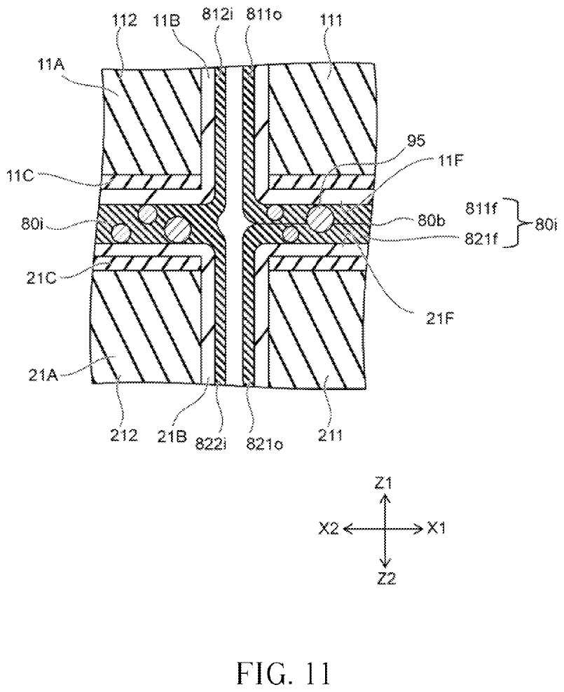

FIG. 11 is a diagram illustrating a detailed structure (fourth specific example) of the first insulator portion provided in the coil component according to an embodiment of the present invention. In the fourth specific example, insulating particles 95 such as oxide-based particles are provided between the first spiral conductor portion 11 and the second spiral conductor portion 21. Inorganic materials such as oxides, carbides, nitrides, and inorganic salts are exemplified as specific examples of the insulating particles 95. For example, silica, alumina, and zirconia can be cited as oxides. Also, for example, silicon carbide and boron nitride can be cited as carbides and nitrides, respectively. Examples of inorganic salts include silicates, phosphates, borates, and carbonates. Examples of such inorganic salts include minerals such as wollastonite, kaolin, and mica. Among these, oxide-based materials such as oxides, silicates, and phosphates are preferable in terms of insulation. For example, the insulating particles 95 preferably contain at least one selected from the group consisting of silicon (Si), phosphorus (P), boron (B), and calcium (Ca). The shape of the insulating particles 95 is not particularly limited as long as they can be positioned between the first spiral conductor portion 11 and the second spiral conductor portion 21. This shape may be a shape close to a sphere, a shape with a large aspect ratio such as a needle shape, or an irregular shape. When cross-sectional observation is performed between the first spiral conductor portion 11 and the second spiral conductor portion 21, it may be preferable that an average circle equivalent diameter of the insulating particles 95 is 0.0010 μm or more and 2.5 μm or less. This average circle equivalent diameter is more preferably 0.020 μm or more, and further preferably 0.050 μm or more. The average circle equivalent diameter is more preferably 2.0 μm or less, and further preferably 1.5 μm or less. Also from the viewpoint of contributing to ensuring insulation between the first spiral conductor portion 11 and the second spiral conductor portion 21 during the manufacturing process of the coil component 100, the insulating particles 95 are preferably hard, and also from this viewpoint, the insulating particles 95 are preferably made of an inorganic material rather than an organic material.

### Modifications

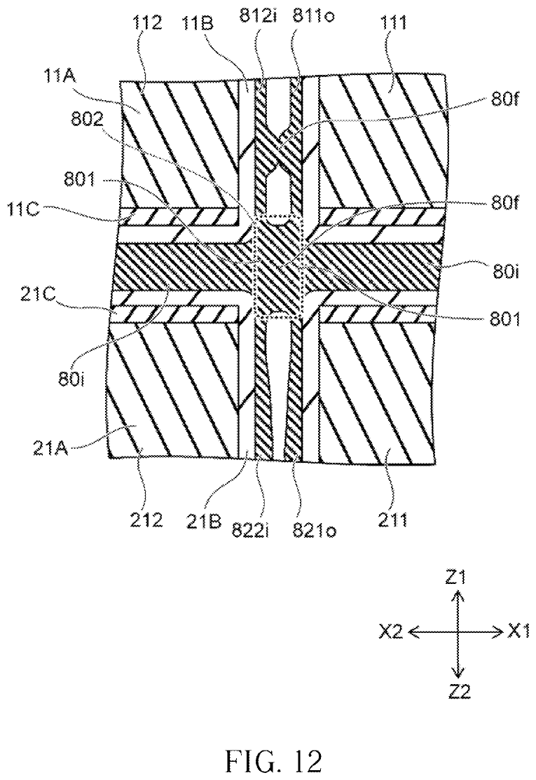

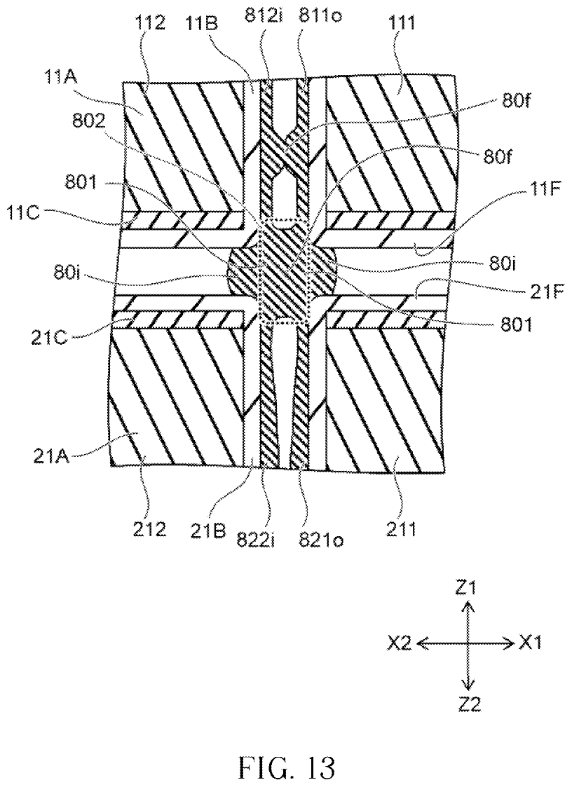

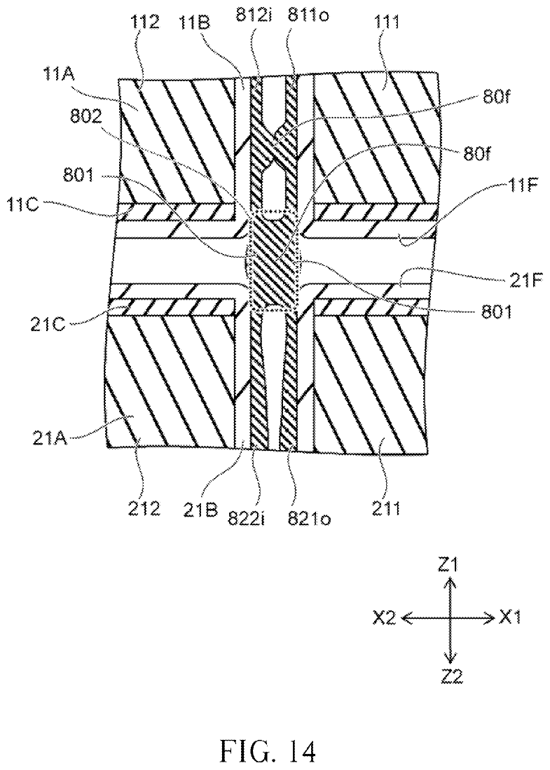

FIGS. 12 to 14 are explanatory diagrams of detailed structures (Modification 1 to Modification 3 of the second specific example) of the first insulator portion provided in the coil component according to an embodiment of the present invention. In Modification 1 shown in FIG. 12, the fusion portion 80f formed by the first connection portion 801 spreads between the side portion of the first inner-side turn 111 and the side portion of the first central turn 112 and between the side portion of the second inner-side turn 211 and the side portion of the second central turn 212, and as a result, the second connection portion 802 spreads in the first direction (Z1-Z2 direction). Both ends of this second connection portion 802 may extend to the first opposite portion 11FA and the second opposite portion 21FA (see FIG. 6), respectively. In Modification 2 shown in FIG. 13, in comparison with Modification 1, the amount of the intervening portion 80i is small, and there are portions where the first insulator portion 80 is not in contact at the first end portion 11F and the second end portion 21F. In Modification 3 shown in FIG. 14, the first insulator portion 80 does not have portions in contact with the first end portion 11F and the second end portion 21F. When the first insulator portion 80 does not exist between the first end portion 11F and the second end portion 21F as shown in FIG. 13 and FIG. 14, it is preferable that the insulating particles 95 exist instead of the first insulator portion 80 so that a short circuit does not occur between the first spiral conductor portion 11 and the second spiral conductor portion 21.

### Modifications Concerning the Second Conductor Portion

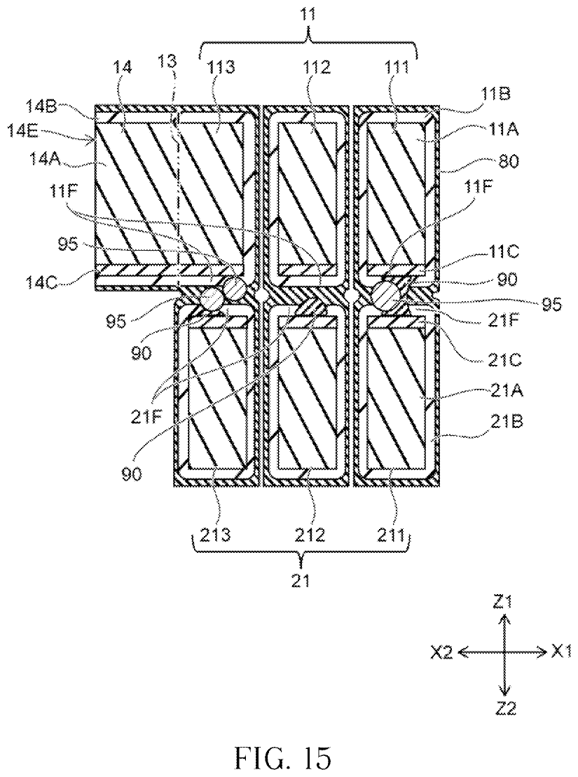

FIG. 15 is an XZ cross-sectional view for illustrating a modified example relating to the second conductor portion provided in the coil component according to an embodiment of the present invention, and corresponds to the XZ cross-sectional view shown in FIG. 6. In the modified example shown in FIG. 15, as compared with the embodiment shown in FIG. 6, the structure of the second conductor portions 11B and 21B positioned at the first end portion 11F and the second end portion 21F is different, and the second conductor portions 11B and 21B do not cover a part of the third conductor portions 11C and 21C.

Specifically, at the first end portion 11F of the first inner-side turn 111, the second insulator portion 90 is positioned so as to cover a part of the third conductor portion 11C, and the second conductor portion 11B partially covers a portion of the third conductor portion 11C not covered by the second insulator portion 90 and a side portion of the second insulator portion 90 (the portion on the X1-X2 direction side in FIG. 15). Also at the second end portion 21F of the second inner-side turn 211, the second insulator portion 90 is positioned so as to cover a part of the third conductor portion 21C, and the second insulator portion 90 is partially covered by the second conductor portion 21B. The second insulator portion 90 covering a part of the first end portion 11F of the first inner-side turn 111 is an integral body with the second insulator portion 90 covering a part of the second end portion 21F of the second inner-side turn 211, and the insulating particles 95 are held by this second insulator portion 90. The second insulator portion 90 is partially in contact with the second conductor portion 11B. And the first insulator portion 80 is positioned so as to cover the second insulator portion 90 and the insulating particles 95.

At the first end portion 11F of the first central turn 112, the third conductor portion 11C is covered by the second conductor portion 11B. On the other hand, at the second end portion 21F of the second inner-side turn 211, similarly to the second end portion 21F of the second inner-side turn 211, the second insulator portion 90 is positioned so as to cover a part of the third conductor portion 11C, and the second conductor portion 11B is positioned so as to cover a part of the side portion of this second insulator portion 90. The space between the first end portion 11F and the second end portion 21F is filled with the first insulator portion 80. At the first end portion 11F of the first outer-side turn 113, insulating particles 95 are positioned so as to adhere to the third conductor portion 11C, and the second conductor portion 11B is positioned so as to cover a portion of the third conductor portion 11C not in contact with the insulating particles 95 and a part of the side portion of the insulating particles 95. At the second end portion 21F of the second outer-side turn 213, the second insulator portion 90 is positioned so as to cover a part of the third conductor portion 11C, and insulating particles 95 adhere to the first end portion 11F side of the second insulator portion 90. Then, the second conductor portion 11B is positioned so as to cover a portion of the third conductor portion 11C where the second insulator portion 90 is not positioned, and this second conductor portion 11B also covers the second insulator portion 90 and is further in contact with the insulating particles 95. The space between the first end portion 11F and the second end portion 21F is filled with the first insulator portion 80.

In this way, in this modified example, substances other than the first insulator portion 80 are positioned between the opposing first end portion 11F and second end portion 21F.

### Second Insulator Portion

In this modified example, the second insulator portion 90 comes into contact with at least one of the first spiral conductor portion 11 and the second spiral conductor portion 21. Thereby, the insulation of the first spiral conductor portion 11 and the second spiral conductor portion 21 is reliably performed. Moreover, since the second insulator portion 90 comes into contact with both between the first spiral conductor portion 11 and the second spiral conductor portion 21, a short circuit between the first spiral conductor portion 11 and the second spiral conductor portion 21 is stably avoided.

The material constituting the second insulator portion 90 is not limited as long as it has appropriate insulating properties. It may be preferable that the second insulator portion 90 has a volume resistivity obtained by ASTM D257 of 1.0×10¹⁴ Ωcm or more. This volume resistivity is more preferably 1.0×10¹⁵ Ωcm or more, and further preferably 1.0×10¹⁶ cm or more. The upper limit of the volume resistivity is not particularly limited. The volume resistivity may be 1.0×1020 Ωcm or less. Furthermore, the second insulator portion 90 preferably has excellent dielectric characteristics, and specifically, it may be preferable that the relative permittivity at 60 Hz obtained by ASTM D150 is 4.0 or less. This relative permittivity is more preferably 3.5 or less, and further preferably 3.0 or less. The upper limit of this relative permittivity is not particularly limited. The relative permittivity may be 1.0 or more. Methods for measuring the volume resistivity and relative permittivity of the second insulator portion 90 are not limited as long as results equivalent to the results obtained by the above ASTM D257 and D150 are expected. For example, a measurement sample obtained by preparing a material corresponding to the second insulator portion 90 to dimensions required for measurement may be separately prepared, and the constituent material may be specified through analytical methods such as component analysis and FT-IR using this measurement sample, and characteristics such as volume resistivity may be evaluated for that material.

The material constituting the second insulator portion 90 may be composed of an organic material, an inorganic material, or a composite material of an organic material and an inorganic material. In a case where the second insulator portion 90 is made of a composite material, the inorganic material may have a particle shape and be dispersed in a matrix made of an organic material. In this case, this inorganic material may be the insulating particles 95. Specific examples of organic materials include polyimide resin, polyethylene resin, polypropylene resin, polyamide resin, polyester resin, polyamide-imide resin, polysulfone resin, polycarbonate resin, liquid crystal polymer resin, polyvinylidene fluoride resin, polytetrafluoroethylene resin, and the like. Inorganic materials such as oxides, carbides, nitrides, and inorganic salts are exemplified as specific examples of inorganic materials, particularly in composite materials. For example, silica, alumina, and zirconia can be cited as oxides. Also, for example, inorganic materials of silicon carbide and boron nitride can be cited as carbides and nitrides, respectively. Minerals such as wollastonite, kaolin, and mica can be cited as inorganic salts. Among these, oxide-based materials such as oxides, silicates, and phosphates are preferable in terms of cost and insulation. For example, it is preferable that the inorganic material contains at least one selected from the group consisting of silicon (Si), phosphorus (P), boron (B), and calcium (Ca).

### Main Body Portion

The main body portion 30 includes a magnetic powder and encloses a part of the coil portion 10. In this embodiment, the main body portion 30 has a substantially rectangular parallelepiped shape and encloses portions other than the first lead-out portion end face 14E and the second lead-out portion end face 24E located at the end portions of the coil portion 10.

The structure of the magnetic powder is not limited. This structure may include a crystalline phase or an amorphous phase. Here, a crystalline material is defined as a material composed of a crystalline phase, an amorphous material is defined as a material composed of an amorphous phase, and a composite material is defined as a material composed of a crystalline phase and an amorphous material. When a diffraction spectrum obtained by a general X-ray diffraction method includes a sharp diffraction peak capable of specifying the type of crystalline phase, the material includes a crystalline phase. Furthermore, when a diffraction spectrum obtained by a general X-ray diffraction method includes a broad peak indicating an amorphous phase, the material includes an amorphous phase. The material also includes an amorphous phase when a DSC curve obtained by differential thermal analysis includes a peak indicating crystallization, that is, heat generation associated with a phase change from an amorphous phase to a crystalline phase.

The material system of the magnetic powder is not limited. Specific examples of crystalline materials include Fe—Si—Cr based alloys, Fe—Ni based alloys, Fe—Co based alloys, Fe—V based alloys, Fe—Al based alloys, Fe—Si based alloys, Fe—Si—Al based alloys, pure iron, and ferrite. Carbonyl iron powder is preferable as the pure iron powder. Specific examples of amorphous materials include Fe—Si—B based alloys, Fe—P—C based alloys, and Co—Fe—Si—B based alloys. Specific examples of composite materials include Fe—Zr based alloys, Fe—Zr—B based alloys, Fe—Si—B—Nb—Cu based alloys, and Fe—Si—B—P—Cu based alloys. When the magnetic powder is a metal powder containing Fe, the synergistic effect of improving magnetic properties is particularly large.

The chemical composition of the magnetic powder is not limited. For example, the Fe—Si—Cr based alloy may consist of 1.0 to 10.0 mass % of Si, 1.0 to 10.0 mass % of Cr, and the balance consisting of Fe and impurities. Also, for example, the Fe—Ni based alloy may consist of 1.0 to 99.0 mass % of Ni, and the balance consisting of Fe and impurities. Furthermore, for example, the Fe—P—C based alloy may consist of 1.0 to 13.0 atomic % of P, 1.0 to 13.0 atomic % of C, and Fe and impurities. This Fe—P—C based alloy may include, as optional elements, one or more selected from the group consisting of Ni, Sn, Cr, B, and Si. In this case, for example, the amount of Ni may be 0 to 10.0 atomic %, the amount of Sn may be 0 to 3.0 atomic %, the amount of Cr may be 0 to 6.0 atomic %, the amount of B may be 0 to 9.0 atomic %, and the amount of Si may be 0 to 7.0 atomic %. The amount of Fe is preferably 65 atomic % or more. Also, for example, the Fe—Si—B—Nb—Cu based alloy may consist of 1.0 to 16.0 atomic % of Si, 1.0 to 15.0 atomic % of B, 0.50 to 5.0 atomic % of Nb, 0.50 to 5.0 atomic % of Cu, and the balance consisting of Fe and impurities. In this case, the amount of Fe is preferably 65 atomic % or more.

The shape of the magnetic powder is not limited. The magnetic powder may be spherical, elliptical, scaly, or may have an irregular shape. The manufacturing method for obtaining these shapes is also not limited.

The particle size distribution of the magnetic powder is not limited. The particle size distribution of the magnetic powder can be obtained, for example, by analyzing an image (secondary electron image) obtained by imaging a cut surface of the main body portion 30 with a scanning electron microscope. For example, the average circle equivalent diameter of the magnetic powder may be 0.50 to 50.0 μm. The distribution of the circle equivalent diameter may include a plurality of peaks.

The magnetic powder may be subjected to a surface insulation treatment. When the magnetic powder is subjected to a surface insulation treatment, the insulation resistance of the main body portion 30 is improved. The type of surface insulation treatment applied to the magnetic powder is not limited. Phosphoric acid treatment, phosphate treatment, oxidation treatment, etc. are exemplified. The magnetic powder may have an insulating coating on the surface of the magnetic particles. This insulating coating may include at least one selected from the group consisting of Si, P, and B, and O (oxygen).

The magnetic powder may be a mixed material in which a plurality of powder materials are mixed. This magnetic powder is preferably a ferromagnetic material, and more preferably a soft magnetic material.

The main body portion 30 may further include any auxiliary materials. Any auxiliary materials are, for example, a binder material and a modifier. The binder material binds particles such as magnetic powder contained in the main body portion 30 to each other. This binder material is preferably an insulating material in order to impart insulation resistance to the main body portion 30.

The binder material may be an organic material or an inorganic material. The organic material may be a resin material. Examples of resin materials include acrylic resin, silicone resin, epoxy resin, phenol resin, urea resin, melamine resin, and polyester resin. The inorganic material may be a glass-based material such as water glass. The binder material may be a product of a reaction such as thermal decomposition, or may be a mixture of a plurality of materials.

The modifier, for example, improves the fluidity of the powder or adjusts the curing speed of the binder material. The modifier may be a glass-based material. The dimensions of the main body portion 30 are not limited. For example, the maximum dimension of the main body portion 30 may be 3.2 mm or less.

### External Electrode

As shown in FIG. 2, the first lead-out portion end face 14E and the second lead-out portion end face 24E located at the end portions of the coil portion 10 are exposed from the main body portion 30 at side surfaces arranged side by side in the X1-X2 direction in the main body portion 30. A first external electrode 41 is provided so as to be in electrical contact with the first lead-out portion end face 14E, and a second external electrode 42 is provided so as to be in electrical contact with the second lead-out portion end face 24E.

As shown in FIG. 1, the first external electrode 41 has a side surface portion 41a covering a side surface on the X2 side in the X1-X2 direction of the main body portion 30, and a bottom surface portion 41b provided so as to cover a part of a bottom surface (surface on the Z2 side in Z1-Z2 direction) of the main body portion 30. The bottom surface portion 41b is a portion facing a substrate during use. The second external electrode 42 has a side surface portion 42a covering a side surface on the X1 side in the X1-X2 direction of the main body portion 30, and a bottom surface portion 42b provided so as to cover a part of the bottom surface while being spaced apart from the bottom surface portion 41b on the bottom surface of the main body portion 30. The bottom surface portion 42b is also a portion facing the substrate during use.

The positions of the first external electrode 41 and the second external electrode 42 are not limited to the above-mentioned positions. The first external electrode 41 and the second external electrode 42 may be formed so as to cover a part of an upper surface (surface on Z1 side in Z1-Z2 direction) of the main body portion 30. Furthermore, the first external electrode 41 and the second external electrode 42 may be provided only on a part of the bottom surface (surface on Z2 side in Z1-Z2 direction) of the main body portion 30. In this case, the coil conductor portion 20 may have a connection conductor portion (not shown) connecting from the two end portions (first lead-out portion 14, second lead-out portion 24) of the coil portion 10 to the bottom surface of the main body portion 30 through the inside of the main body portion 30. In this case, the two end portions of the coil portion 10 (first lead-out portion end face 14E, second lead-out portion end face 24E) may not be exposed on the side surfaces of the main body portion 30, and the connection conductor portion may be exposed on the bottom surface of the main body portion 30.

The materials and configurations of the first external electrode 41 and the second external electrode 42 are not limited as long as they have appropriate conductivity. Non-limiting examples of the first external electrode 41 and the second external electrode 42 include a layer having a structure of Cu plating/Ni plating/Sn plating from the side proximal to the surface of the main body portion 30. The first external electrode 41 and the second external electrode 42 may be composed of application-type electrodes in which a conductive substance such as silver is dispersed in a resin or the like. Moreover, the first external electrode 41 and the second external electrode 42 may be a combination of plating and an application-type electrode.

### Outer Cover

Insulating outer covers 50 and 60 are respectively provided on an upper surface (surface on Z1 side in Z1-Z2 direction) and side surfaces lined up in the Y1-Y2 direction of the main body portion 30. An insulating outer cover may also be provided on portions of the bottom surface of the main body portion 30 where the bottom surface portions 41b and 42b are not provided. Also, the coil component 100 may not be provided with the outer covers 50 and 60. These outer covers 50 and 60 can be formed at arbitrary positions on the surface of the main body portion 30 depending on the purpose.

### Manufacturing Method

The method for manufacturing the coil component 100 according to the present embodiment is not particularly limited. A non-limiting example of the manufacturing method is as follows.

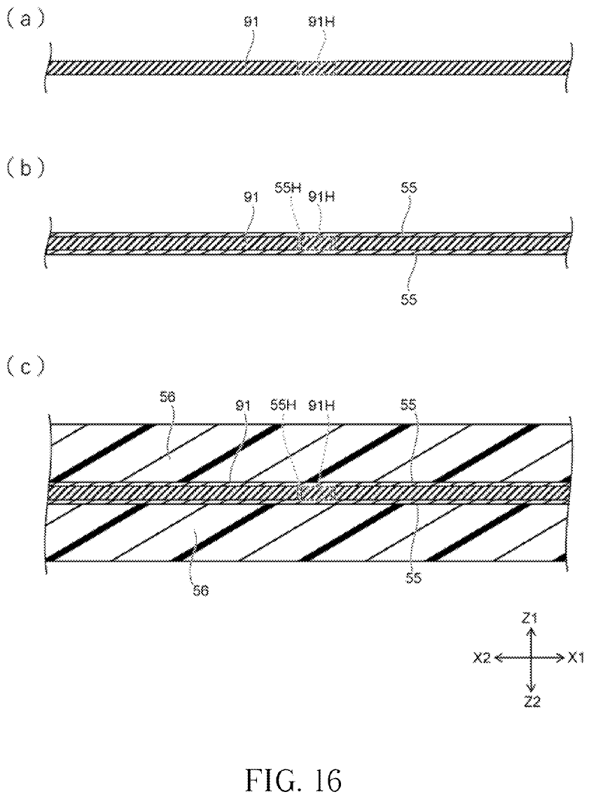

FIG. 16 to FIG. 20 are explanatory diagrams (Part 1 to Part 5) illustrating an example of the method for manufacturing the coil component according to an embodiment of the present invention.

### (a) Preparation of Sheet Substrate

First, as shown in FIG. 16(a), a sheet substrate 91 having a substrate through hole 91H provided at a position corresponding to the via portion VP is prepared. As long as the sheet substrate 91 has mechanical characteristics to function as a support when forming the first spiral conductor portion 11 and the second spiral conductor portion 21, there are no restrictions on its material. It may be preferable that the sheet substrate 91 has appropriate insulating properties required as a raw material for the second insulator portion 90, and it is preferable to have appropriate removal characteristics at least in part when removing the sheet substrate 91 as described later.

The thickness of the sheet substrate 91 is set in consideration of properly functioning as a support when forming the first spiral conductor portion 11 and the second spiral conductor portion 21, and, if necessary, the insulating properties of the second insulator portion 90 derived from the sheet substrate 91 and the removal characteristics of the sheet substrate 91. As a non-limiting example, the thickness of the sheet substrate 91 is 0.4 μm or more and 20 μm or less. The thickness of this sheet substrate 91 may be 1.0 μm or more, or 5.0 μm or more. Furthermore, in order to further reduce the size of the coil component 100, the thickness of the sheet substrate 91 may be 14.0 μm or less.

Examples of the constituent material of the sheet substrate 91 include an organic material, an inorganic material, and a composite material thereof. Specific examples of the organic material include thermoplastic resins such as polyimide resin and polyethylene resin, thermosetting resins such as epoxy resin and phenol resin, and cellulose. Specific examples of the inorganic material include oxide-based materials such as glass and alumina, metal-based materials such as aluminum and magnesium, and inorganic salt-based materials such as calcium carbonate. A specific example of the composite material is a structure in which powder of an inorganic material (inorganic particles) is dispersed in a matrix portion made of an organic material.

### (b) Formation of Conductive Layer

A pattern 11CP of a third conductor portion 11C corresponding to the first conductor portion 11A is formed on one surface (surface on the Z1 side in the Z1-Z2 direction) of the prepared sheet substrate 91, and a pattern 21CP of a third conductor portion 21C corresponding to the first conductor portion 21A is formed on the other surface (surface on the Z2 side in the Z1-Z2 direction) of the sheet substrate 91.

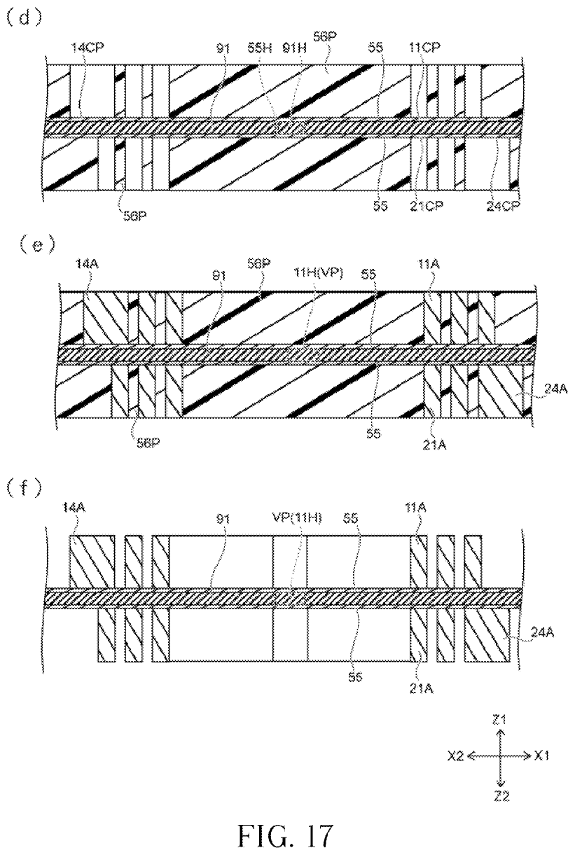

The specific method for forming the pattern 11CP of the third conductor portion 11C and the pattern 21CP of the third conductor portion 21C is not limited. For example, the methods shown in FIG. 16(b) to FIG. 17(d) are exemplified. First, as shown in FIG. 16(b), a conductive layer 55 made of the same material as the third conductor portions 11C, 14C, 21C, 24C is formed on both surfaces of the sheet substrate 91 (surfaces on both sides in the Z1-Z2 direction). The formation method of the conductive layer 55 is not limited. The conductive layer 55 may be formed by a dry process such as sputtering, or may be formed by a wet process such as electroless plating. From the viewpoint of reducing the thickness of the conductive layer 55, it is preferable that the conductive layer 55 is formed by sputtering.

In this example, as shown in FIG. 16(b), a conductive layer 55H is also formed on an inner side surface of the substrate through hole 91H. Note that a member in which the conductive layers 55 are previously provided on both surfaces of the sheet substrate 91, such as a copper-clad laminate, may be prepared, and the substrate through hole 91H may be provided in this. In this case, the material of the sheet substrate 91 may be exposed on the inner side surface of the substrate through hole 91H, or a process of separately providing the conductive layer 55H may be performed.

### (c) Formation of Insulating Layer

Next, as shown in FIG. 16(c), an insulating layer 56 made of a patternable material such as a dry film resist is laminated on each of the conductive layers 55 provided on both surfaces of the sheet substrate 91. By forming the thicknesses of the insulating layers 56 to be thicker than the thickness of the first conductor portion 11A and thicker than the thickness of the first conductor portion 21A, the shape controllability of the first conductor portion 11A and the second conductor portion 21B can be improved.

### (d) Formation of Pattern of Third Conductor Portion

Subsequently, an exposure and development process is performed on the insulating layers 56 on both sides in the Z1-Z2 direction, and a part of the insulating layers 56 is removed to form a negative pattern 56P having inverted shapes of the pattern 11CP of the third conductor portion 11C corresponding to the first conductor portion 11A, which is the first portion, and the pattern 21CP of the third conductor portion 21C corresponding to the first conductor portion 21A, which is the second portion. As a result, parts of the conductive layers 55 on both sides in the Z1-Z2 direction are exposed, and as shown in FIG. 17(d), the pattern 11CP of the third conductor portion 11C and the pattern 21CP of the third conductor portion 21C are formed.

When exposing and developing the insulating layers 56 on both sides in the Z1-Z2 direction, by removing portions corresponding to the third conductor portion 14C of the first lead-out portion 14 and the third conductor portion 24C of the second lead-out portion 24, the negative pattern 56P on the Z1 side in the Z1-Z2 direction forms a pattern 14CP of the third conductor portion 14C, and the negative pattern 56P on the Z2 side in the Z1-Z2 direction can form a pattern 24CP of the third conductor portion 24C. As a result, as shown in FIG. 17(d), the pattern 14CP of the third conductor portion 14C corresponding to the first conductor portion 14A is continuously formed with the pattern 11CP of the third conductor portion 11C corresponding to the first conductor portion 11A, and the pattern 24CP of the third conductor portion 24C corresponding to the first conductor portion 24A is continuously formed with the pattern 21CP of the third conductor portion 21C corresponding to the first conductor portion 21A. Hereinafter, these patterns may be collectively referred to as “patterns of the third conductor portion”. The pattern of the third conductor portion has a shape corresponding to the first portion (first conductor portion 11A) and the second portion (first conductor portion 21A).

### (e) Formation of First Conductor Portion

Thus, after the patterns of the third conductor portion are formed, a first plating process is performed (FIG. 17(e)). The first plating process is an electroplating process, and the processing region of the main surface of the sheet substrate 91 in the electroplating process has the patterns of the third conductor portion. Specifically, in the first plating process, an electric current is applied to the conductive layers 55 provided on both surfaces of the sheet substrate 91 to form the first conductor portion 11A and the first conductor portion 14A, as well as the first conductor portion 21A and the first conductor portion 24A on the patterns of the third conductor portion.

Since the negative pattern 56P formed from the insulating layer 56 is disposed on the periphery of the patterns of the third conductor portion, in the first plating process, by performing electroplating using the negative pattern 56P as a masking material, the first conductor portion 11A and the first conductor portion 14A are integrally formed, and the first conductor portion 21A and the first conductor portion 24A are integrally formed corresponding to the patterns of the third conductor portion. Further, in the first plating process, a via conductor portion 11H is formed as a third portion so as to fill the substrate through hole 91H. Since this via conductor portion 11H constitutes the via portion VP, the via portion VP is integrally formed with both the first spiral conductor portion 11 and the second spiral conductor portion 21 in the first plating process step.

The plated deposit formed by electroplating is not limited as long as it has appropriate conductivity. As mentioned above, materials containing Cu such as Cu and Cu alloys are non-limiting examples.

### (f) Removal of Negative Pattern

Thus, after the first conductor portions 11A, 21A and the first conductor portions 14A, 24A are formed on both surfaces of the sheet substrate 91, the negative pattern 56P made of the insulating layer 56 is peeled off. As a result, as shown in FIG. 17(f), on the sheet substrate 91, a structure is obtained in which the conductive layer 55 is positioned over the entire surface except for the substrate through hole 91H, and the first conductor portions 11A, 21A and the first conductor portions 14A, 24A are disposed on the conductive layer 55. As described above, the first conductor portion 11A and the first conductor portion 21A are electrically connected by the via conductor portion 11H constituting the via portion VP.

### (g) Removal of Conductive Layer

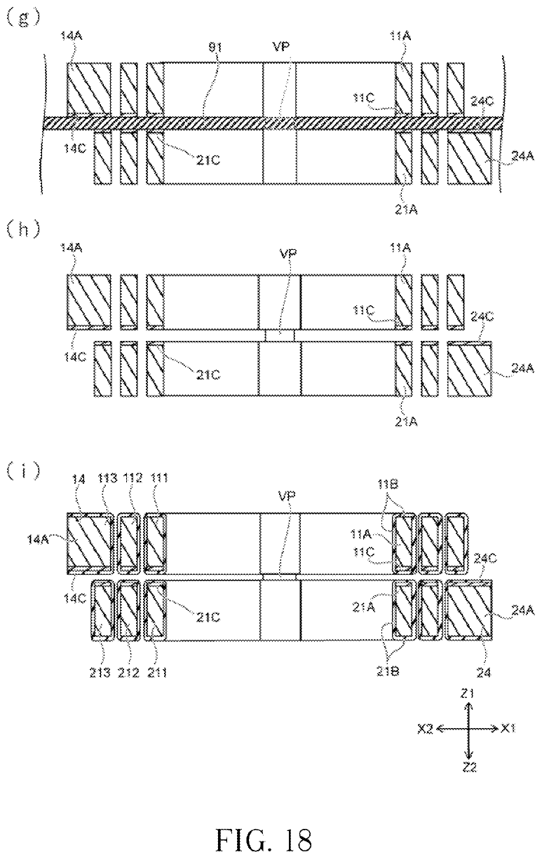

Subsequently, portions of the conductive layer 55 on the sheet substrate 91 exposed in the first direction (Z1-Z2 direction), specifically portions not covered by the first conductor portions 11A, 21A and the first conductor portions 14A, 24A, are removed. As a result, as shown in FIG. 18(g), the conductive layer 55 remaining on the sheet substrate 91 becomes the third conductor portions 11C, 14C, 21C, 24C serving as components of the coil portion 10.

The removal method of the conductive layer 55 is not limited. A process capable of removing the material constituting the conductive layer 55 and having little influence on the first conductor portions 11A, 21A and the first conductor portions 14A, 24A may be appropriately selected. For example, when the first conductor portions 11A, 21A and the first conductor portions 14A, 24A are made of Cu and the conductive layer 55 is made of Ni, the portions of the conductive layer 55 not covered by the first conductor portions 11A, 21A and the first conductor portions 14A, 24A can be etched with high selectivity. If the constituent material of the conductive layer 55 is the same type as the first conductor portions 11A, 21A and the first conductor portions 14A, 24A, the first conductor portions 11A, 21A and the first conductor portions 14A, 24A are also partially removed by the process capable of removing the material constituting the conductive layer 55, but the shape of the electroplated deposit formed in the first plating process may be made into a shape taking this removed amount into consideration.

### (h) Removal of Sheet Substrate

Subsequently, a removal process is performed to remove at least a part of a first opposing portion facing a surface (surface on Z2 side in Z1-Z2 direction) of the first portion (first conductor portion 11A) on a side proximal to the second portion (first conductor portion 21A) and a second opposing portion facing a surface (surface on Z2 side in Z1-Z2 direction) of the second portion (first conductor portion 21A) on a side proximal to the first portion (first conductor portion 11A) in the sheet substrate 91. In FIG. 18(h), all of the first opposing portion and all of the second opposing portion in the sheet substrate 91 are removed. The specific method of the removal process of the sheet substrate 91 is appropriately set according to the constituent material of the sheet substrate 91. The removal process is broadly classified into a dry process such as plasma etching and a wet process such as wet etching. From the viewpoint of appropriately removing the sheet substrate 91 located between the members constituting the first spiral conductor portion 11 (first conductor portion 11A, third conductor portion 11C) and the members constituting the second spiral conductor portion 21 (first conductor portion 21A, third conductor portion 21C), wet etching, which is an isotropic removal process, may be preferable. A part of the sheet substrate 91 may be removed by the removal process, and there may be a remaining portion not removed. For example, the sheet substrate 91 may be made of a composite material of an organic material and an inorganic material, and the organic material may be partially removed in the removal process. In this way, the insulating material constituting the sheet substrate 91 may partially remain, and the remaining insulating material constitutes the second insulator portion 90 and the insulating particles 95. By forming the second conductor portions 11B, 21B described next with such insulating material remaining, a structure as shown in FIG. 15 is obtained.

### (i) Formation of Second Conductor Portion

By removing the sheet substrate 91 as described above, not only the first conductor portions 11A, 14A, 21A, 24A but also the third conductor portions 11C, 14C, 21C, 24C are exposed. In this state, by performing a second plating process, second conductor portions 11B, 21B are formed on surfaces of the first conductor portions 11A, 21A and the third conductor portions 11C, 21C, and second conductor portions 14B, 24B are formed on surfaces of the first conductor portions 14A, 24A and the third conductor portions 14C, 24C. The plating process of the second plating process step may be an electroplating (electrolytic plating) process or an electroless plating process.

By performing the second plating process, as shown in FIG. 18(i), the second conductor portion 11B is provided around the first conductor portion 11A and the third conductor portion 11C to form the first spiral conductor portion 11, and the second conductor portion 21B is provided around the first conductor portion 21A and the third conductor portion 21C to form the second spiral conductor portion 21. Further, the second conductor portion 14B is provided around the first conductor portion 14A and the third conductor portion 14C to form the first lead-out portion 14, and the second conductor portion 24B is provided around the first conductor portion 24A and the third conductor portion 24C to form the second lead-out portion 24. In this case, the second conductor portions 11B, 21B, 14B, 24B have a continuous portion formed between intersecting outer surfaces, and a smooth corner portion is formed. As a result, the first insulator portion 80 to be formed subsequently is easily formed, and is less likely to peel off even when it comes into contact with the constituent material of the main body portion 30, such as magnetic powder.

### (j) Formation of Second Insulator Portion

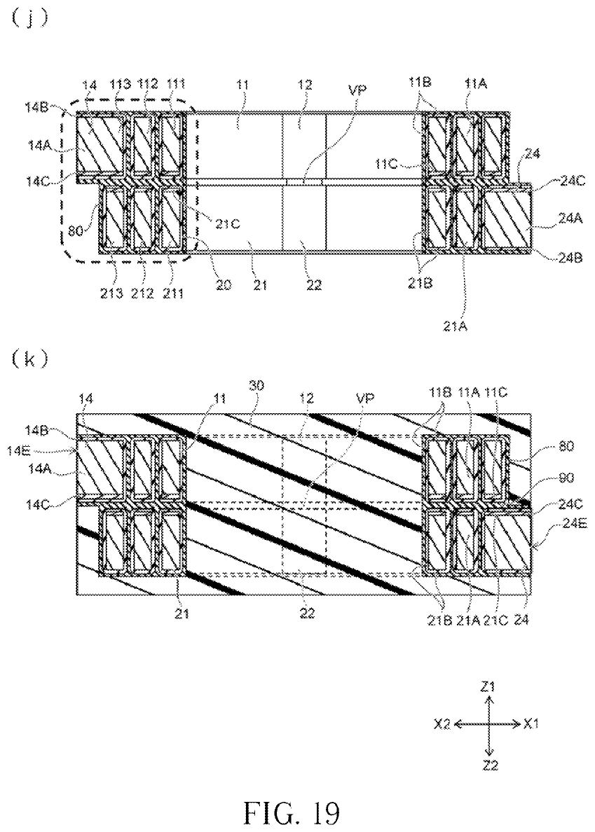

When the second conductor portions 11B, 21B, 14B, 24B are thus formed by the second plating process, a first insulator portion 80 made of an insulating material is formed so as to cover at least a part of exposed portions of the coil conductor portion 20. In FIG. 19(j), the first insulator portion 80 is provided on exposed surfaces of the first spiral conductor portion 11 and the second spiral conductor portion 21 constituting the coil conductor portion 20 (both of these are made of the second conductor portions 11B, 21B), an exposed surface of the first lead-out portion 14 other than the surface facing the X1-X2 direction (made of the second conductor portion 14B), and an exposed surface of the second lead-out portion 24 other than the surface facing the X1-X2 direction (made of the second conductor portion 24B). External electrodes (first external electrode 41, second external electrode 42) are provided on the surfaces where the first insulator portion 80 is not provided.

The formation process of the first insulator portion 80 is appropriately set according to the constituent material of the first insulator portion 80. For example, when the first insulator portion 80 is made of a parylene-based polymer, it is formed by a dry process (CVD). When the first insulator portion 80 contains a curable resin material such as epoxy resin, it can be formed by attaching a powder or a liquid containing the constituent material of the first insulator portion 80 to the exposed surface, and then solidifying the attached matter by heating or the like.

### (k) Formation of Main Body Portion

When the coil portion 10 is formed by the above steps, as a next step, as shown in FIG. 19(k), the main body portion 30 is formed by sealing a part of the first lead-out portion 14 and the second lead-out portion 24 in the coil portion 10, specifically portions other than the first lead-out portion end face 14E and the second lead-out portion end face 24E in this embodiment, with a material containing magnetic powder. The formation method of the main body portion 30 is not limited, and a molding process is exemplified. Specific examples of the molding process include arranging the product shown in FIG. 19(j) in a mold and forming it by compression molding of a material containing magnetic powder, or transfer molding a material containing magnetic powder or a member serving as a raw material for the material.

The method for forming the main body portion 30 such that the first lead-out portion end face 14E and the second lead-out portion end face 24E are exposed from the main body portion 30 is not limited. For example, the main body portion 30 may be formed after masking the first lead-out portion end face 14E and the second lead-out portion end face 24E. Alternatively, it can also be formed by continuously providing a dummy member so as to cover or integrally connect the first lead-out portion end face 14E and the second lead-out portion end face 24E, forming the first insulator portion 80 on the surface of the dummy member, then forming the main body portion 30, and thereafter cutting the dummy member to expose the first lead-out portion end face 14E and the second lead-out portion end face 24E.

### (l) Formation of Outer Cover

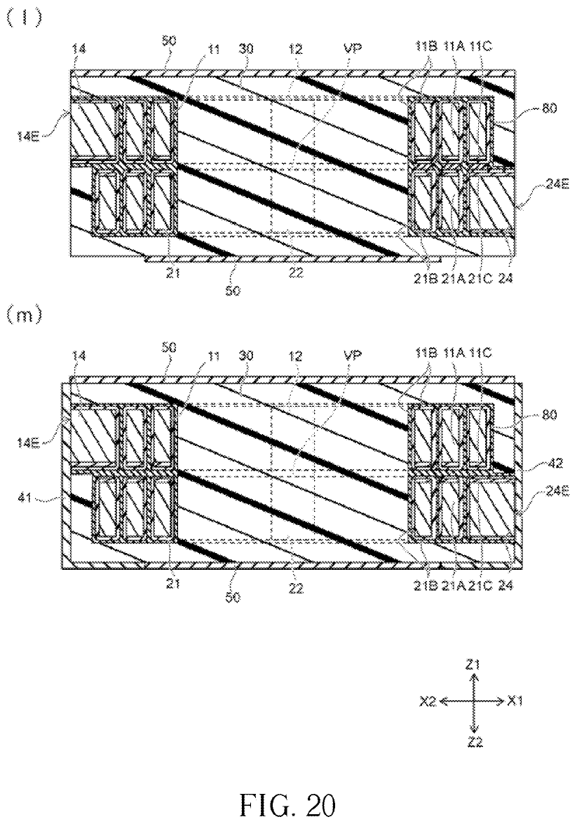

Next, an outer cover 50 is applied to a part of exposed portions of the main body portion 30, which are portions where neither the first external electrode 41 nor the second external electrode 42 is formed on an upper surface (surface on the Z1 side in the Z1-Z2 direction) and a lower surface (surface on the Z2 side in the Z1-Z2 direction) of the main body portion 30 in FIG. 20(l), to protect the main body portion 30. Although the main body portion 30 may be left as it is, when an external force is applied based on collisions with other members, the insulating coating on the surface of the magnetic powder constituting the main body portion 30 is scraped off, which may lower the resistance of the surface of the main body portion 30. Since the decrease in surface insulation may cause a decrease in reliability of the coil component 100, it is preferable to provide the outer cover 50 made of an insulating material. The formation method of the outer cover 50 is not limited. Known methods such as printing and coating may be employed. The constituent material of the outer cover 50 may be a known material such as epoxy resin, and from the viewpoint of improving impact resistance, a composite material in which an inorganic material such as glass fiber is dispersed in an organic material such as epoxy resin is preferable in some cases. Furthermore, the outer cover 50 may be formed for the purpose of improving appearance quality or improving the positional accuracy of the external electrodes (e.g., prevention of plating spread) formed in the next step, in addition to improving insulation reliability and impact resistance. The outer cover 60 may be formed simultaneously when forming the outer cover 50, or may be formed by a separate process.

### (m) Formation of External Electrode

Finally, one of two terminal portions (first external electrode 41) is electrically connected to a part of the first lead-out portion 14 (first lead-out portion end face 14E) that was not sealed with the material containing magnetic powder when forming the main body portion 30, and the other of the two terminal portions (second external electrode 42) is electrically connected to a part of the second lead-out portion 24 (second lead-out portion end face 24E). The method for forming the first external electrode 41 and the second external electrode 42 is not limited, and a plating process and a printing process are exemplified. In FIG. 20(m), the first external electrode 41 and the second external electrode 42 are formed to extend not only to side surfaces (surfaces facing the X1-X2 direction) of the main body portion 30 but also to a part of the bottom surface (surface on the Z2 side in the Z1-Z2 direction) of the main body portion 30. As described above, by forming the external electrodes (first external electrode 41 and second external electrode 42) after forming the outer cover 50, it is possible to prevent a problem (plating spread) in which a plated deposit is formed in an unexpected area on the exposed surface of the main body portion 30, thereby lowering the shape accuracy of the external electrodes or increasing the risk of short-circuiting of the external electrodes. From this viewpoint, it is preferable that the outer cover 50 is also formed on the lower surface (Z2 side in the Z1-Z2 direction) serving as a mounting surface in the outer cover formation process, as in the present embodiment.

### Electronic/Electric Device

An electronic/electric device according to an embodiment of the present invention is an electronic/electric device on which the coil component 100 according to an embodiment of the present invention is mounted, and the coil component 100 is connected to a substrate by the first external electrode 41 and the second external electrode 42. Since the electronic/electric device according to an embodiment of the present invention is mounted with the coil component 100 according to an embodiment of the present invention, it is easy to miniaturize the device. In addition, even if a large current is applied or a high frequency is applied within the device, defects caused by functional degradation or heat generation of the coil component 100 are less likely to occur.

The embodiments and examples described above are provided to facilitate an understanding of the present invention, and are not described to limit the present invention. Therefore, each element disclosed in the above embodiments is intended to include all design changes and equivalents belonging to the technical scope of the present invention. For example, in the above manufacturing method, a process of removing the third conductor portions 11C, 21C, 14C, 24C may be performed between the removal process of the sheet substrate 91 shown in FIG. 18(h) and the second plating process shown in FIG. 18(i). This process may be the same processing method as the removal of the conductive layer 55 shown in FIG. 18(g). As a result, the coil conductor portion 20 has a structure that does not include the third conductor portions 11C, 21C, 14C, 24C.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A coil component, comprising:
a coil conductor portion, comprising: a first spiral conductor portion and a second spiral conductor portion, each having a spiral shape when viewed in a first direction and aligned in the first direction; and a via portion electrically connecting an inner peripheral end portion of the first spiral conductor portion and an inner peripheral end portion of the second spiral conductor portion, wherein the coil conductor portion has a conductive path from an outer peripheral end portion of the first spiral conductor portion via the via portion to an outer peripheral end portion of the second spiral conductor portion,
the coil conductor portion further comprising:
a first conductor portion extending along the conductive path and made of a first conductive material; and
a second conductor portion made of a second conductive material and covering at least a part of the first conductor portion,
wherein the second conductor portion is at least partially provided on a first end portion of the first spiral conductor portion on a side facing the second spiral conductor portion.

2. The coil component according to claim 1, wherein at least a part of turns of the first spiral conductor portion comprises a first corner portion connecting a surface of the first end portion and a side surface along the first direction with a continuous surface.

3. The coil component according to claim 2, wherein in a first cross section obtained by cutting along a plane passing through the first corner portion and along the first direction, a cross-sectional line drawn by the first corner portion has a shape approximating an arc having a larger radius of curvature than a cross-sectional line drawn by an interface between the second conductor portion and a portion made of a conductive material located inside the second conductor portion in the first cross section.

4. The coil component according to claim 1, further comprising a third conductor portion made of a third conductive material between the second conductor portion provided at the first end portion and the first conductor portion covered by the second conductor portion.

5. The coil component according to claim 1, wherein the second conductor portion is provided on at least a part of a second end portion of the second spiral conductor portion on a side facing the first spiral conductor portion.

6. The coil component according to claim 5, wherein at least a part of turns of the second spiral conductor portion has a second corner portion connecting a surface of the second end portion and a side surface along the first direction with a continuous surface.

7. The coil component according to claim 6, wherein in a second cross section obtained by cutting along a plane passing through the second corner portion and along the first direction, a cross-sectional line drawn by the second corner portion has a shape approximating an arc having a larger radius of curvature than a cross-sectional line drawn by an interface between a portion made of a conductive material located inside the second conductor portion and the second conductor portion in the second cross section.

8. The coil component according to claim 5, further comprising a third conductor portion made of a third conductive material between the second conductor portion provided at the second end portion and the first conductor portion covered by the second conductor portion.

9. The coil component according to claim 1, wherein at least one of the first spiral conductor portion and the second spiral conductor portion has two turns arranged in a direction intersecting the first direction, and further comprises a first insulator portion covering at least a part of two opposing side surfaces in the two turns.

10. The coil component according to claim 9, wherein the first insulator portion comprises:
a portion in contact with one of the two turns;
a portion in contact with the other of the two turns; and
a first connection portion extending continuously from these portions in a direction intersecting the first direction,
wherein the first connection portion comprises a thin portion whose thickness in the first direction is smaller than a portion in contact with either of the two turns in the first insulator portion.

11. The coil component according to claim 9, wherein:
the first insulator portion comprises an intervening portion located between a turn of the first spiral conductor portion and a turn of the second spiral conductor portion, and
at least one of a boundary surface and a pore is present in the intervening portion.

12. The coil component according to claim 9, wherein the first insulator portion is present so as to cover each of the two opposing side surfaces in the two turns, and at least one of a line segment boundary and a closed space is present between the first insulator portions.

13. The coil component according to claim 9, wherein a second insulator portion made of a material different from a material constituting the first insulator portion is located in at least a part between the first spiral conductor portion and the second spiral conductor portion.

14. The coil component according to claim 13, further comprising a third conductor portion made of a third conductive material between the second conductor portion provided at the first end portion and the first conductor portion covered by the second conductor portion.

15. The coil component according to claim 1, further comprising: a main body portion containing magnetic powder and covering portions other than two end portions of the coil conductor portion; and external electrodes provided on the main body portion and electrically connected to each of the two end portions of the coil conductor portion exposed from the main body portion.

16. A method for manufacturing a coil component, the coil component comprising a coil conductor portion including a first spiral conductor portion and a second spiral conductor portion, each having a spiral shape when viewed in a first direction and arranged alongside in the first direction, and a via portion electrically connecting an inner peripheral end portion of the first spiral conductor portion and an inner peripheral end portion of the second spiral conductor portion, and the coil conductor portion having a conductive path from an outer peripheral end portion of the first spiral conductor portion to an outer peripheral end portion of the second spiral conductor portion via the via portion, wherein:
the coil conductor portion further comprises:
a first conductor portion extending along the conductive path and made of a first conductive material, and a second conductor portion made of a second conductive material and covering at least a part of the first conductor portion,
the first conductor portion comprises a first portion corresponding to the first spiral conductor portion, a second portion corresponding to the second spiral conductor portion, and a third portion corresponding to the via portion, and
the method comprises:
forming the first portion on one of main surfaces of an insulating sheet substrate having a through hole, forming the second portion on the other of the main surfaces of the sheet substrate, and forming the third portion inside the through hole;
for the sheet substrate, removing a portion that faces neither the first portion nor the second portion, and removing at least a part of a first opposing portion facing a surface of the first portion on a side proximal to the second portion, and a second opposing portion facing a surface of the second portion on a side proximal to the first portion; and
forming the second conductor portion so as to cover an exposed portion of a member made of a conductive material including the first conductor portion.

17. The method for manufacturing the coil component according to claim 16, wherein the second conductor portion is formed by a plating process.

18. The method for manufacturing the coil component according to claim 17, wherein:
the main surface of the sheet substrate has a third conductor portion made of a third conductive material,
the first conductor portion is formed by an electroplating process applying an electric current to the third conductor portion, and
the exposed portion where the second conductor portion is formed has a portion composed of the third conductor portion.

19. The method for manufacturing the coil component according to claim 18, wherein:
a processing region of the main surface of the sheet substrate for the electroplating process comprises a negative pattern of an insulating layer formed on the third conductor portion, and
prior to the removal of the sheet substrate, portions of the insulating layer and the third conductor portion that do not contact the first conductor portion are removed.

20. The method for manufacturing the coil component according to claim 19, wherein the third conductive material has different etching characteristics from the first conductive material.

21. The method for manufacturing the coil component according to claim 18, wherein a processing region of the main surface of the sheet substrate for the electroplating process comprises a pattern of the third conductor portion having a shape corresponding to the first portion and the second portion.

22. The method for manufacturing the coil component according to claim 16, wherein an insulating material constituting the sheet substrate remains in at least a part between the first portion and the second portion.

23. The method for manufacturing the coil component according to claim 22, wherein the insulating material has a portion in contact with the first portion and the second portion.

24. The method for manufacturing the coil component according to claim 22, wherein the sheet substrate has a structure in which inorganic particles are dispersed in a matrix portion made of an organic material, and the insulating material comprises the inorganic particles.

25. The method for manufacturing the coil component according to claim 16, further comprising forming a first insulator portion so as to cover at least a part of the second conductor portion.
